(19) United States
(12) Patent Application Publication
(10) Pub. No.: US 2026/0252321 A1
(43) Pub. Date: Aug. 27, 2026

(54) SYSTEM

(71) Applicant: SoftBank Group Corp., Tokyo (JP)

(72) Inventor: Ryutaro OKAMOTO, Tokyo (JP)

(73) Assignee: SoftBank Group Corp., Tokyo (JP)

(21) Appl. No.: 19/542,675

(22) Filed: Feb. 18, 2026

Related U.S. Application Data
(60) Provisional application No. 63/761,160, filed on Feb. 21, 2025.

(30) Foreign Application Priority Data
Feb. 21, 2025 (JP) 2025-026978

(51) Int. Cl. G06F 8/35; G06F 8/10; G06F 8/41

(52) U.S. Cl. CPC G06F 8/35; G06F 8/10; G06F 8/433

(57) ABSTRACT

The system according to the embodiment comprises a reception unit, a generation unit, a confirmation unit, and a variation providing unit. The reception unit inputs acceptance conditions. The reception unit inputs source code of a target system. The generation unit generates source code for modification based on information input by the reception unit. The confirmation unit confirms the source code generated by the generation unit. The variation providing unit provides a plurality of source code variations generated by the generation unit.

### CROSS-REFERENCE TO RELATED APPLICATION

The present application claims priority to and incorporates by reference the entire contents of Japanese Patent Application No. 2025-026978 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, it has been difficult to efficiently generate acceptance conditions for tickets and source code for modifications in agile development, and there is room for improvement in workload estimation and coding accuracy.

### SUMMARY OF THE INVENTION

The system according to the embodiment comprises a reception unit, a generation unit, a confirmation unit, and a variation providing unit. The reception unit inputs acceptance conditions. The reception unit inputs source code of a target system. The generation unit generates source code for modification based on information input by the reception unit. The confirmation unit confirms the source code generated by the generation unit. The variation providing unit provides a plurality of source code variations generated by the generation unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

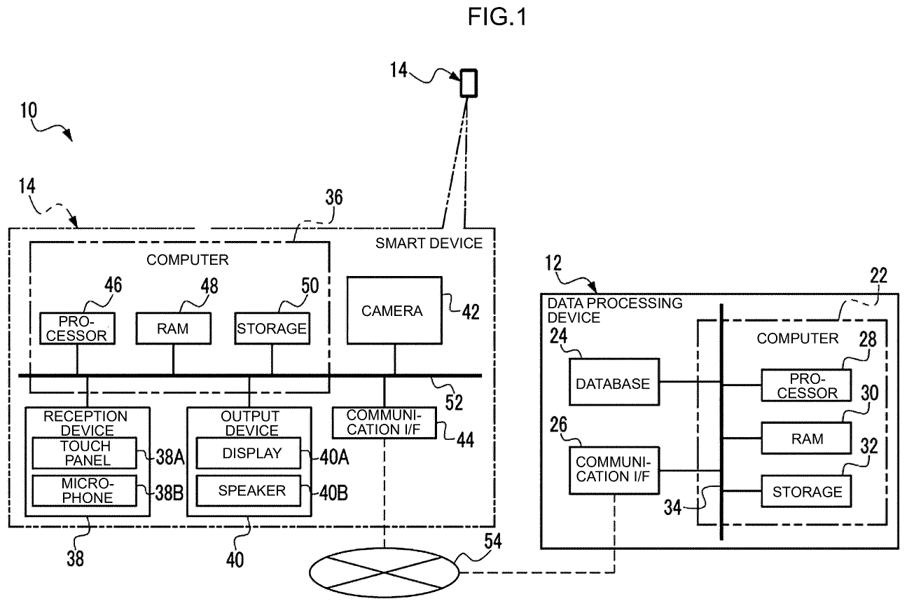

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

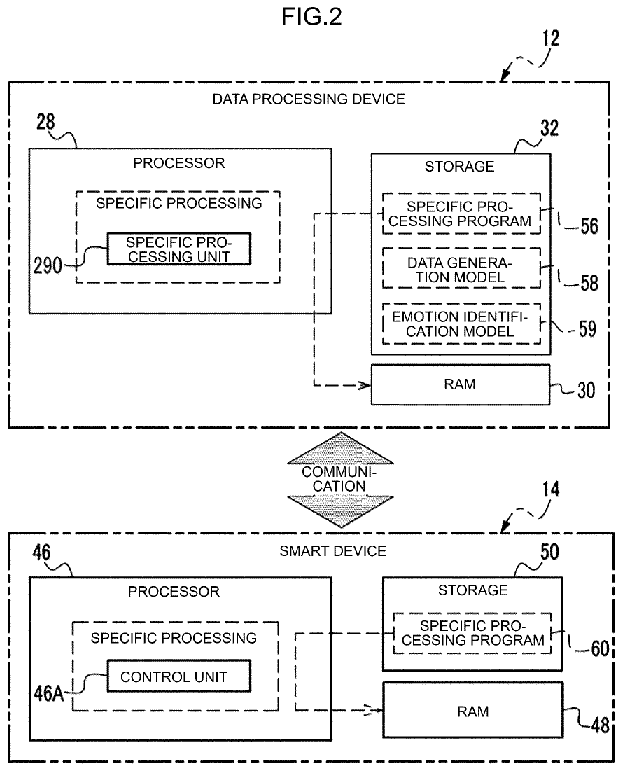

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The system according to the embodiment of the present invention is a system in which AI generates source code for modification based on acceptance conditions for tickets in agile development and the source code of a target system as inputs. This system is used by developers to estimate the workload of tickets and to improve coding accuracy. For example, a developer inputs the acceptance conditions for a ticket into the system and inputs the source code of the target system into the system. The system, based on these inputs, uses AI to generate source code for modification. The generated source code can be confirmed by the developer and modified as necessary. With this system, developers can accurately estimate the workload of tickets and improve coding accuracy. For example, when it is necessary to add or modify a certain function, the developer describes the content in the ticket and inputs it into the system. The system uses AI to generate optimal source code for modification and provides it to the developer. The developer can proceed with work based on the generated source code and carry out development efficiently. Thus, the system enables developers to accurately estimate the workload of tickets and improve coding accuracy. Specifically, the system is composed of multiple modules such as a reception unit, a generation unit, a confirmation unit, and a variation providing unit. The system, in the reception unit, receives acceptance conditions input by the developer (e.g., natural language text for functional requirements, non-functional requirements, constraint conditions, JSON structured data, or tabular data) and the source code of the target system (e.g., program files in Python, Java, C++, directory structures, dependency information, etc.). The reception unit performs preprocessing of input data, such as tokenization and syntactic analysis of natural language text, conversion of code to AST (Abstract Syntax Tree), and generation of dependency graphs. The generation unit uses, for example, large-scale language models based on Transformer or encoder-decoder neural networks specialized for code generation. The generation unit inputs the acceptance condition text and the AST representation of the source code as multidimensional tensors (e.g., acceptance conditions up to 4096 tokens, source code up to 10,000 tokens in sequence) into the model. Examples of input include acceptance conditions such as “Add user authentication function” or “Make the existing database access part asynchronous,” and corresponding fragments of module source code. The generation unit outputs fragments of source code after modification (e.g., new function definitions, modifications to existing functions, additional comments) as token sequences or file units. Examples of output include “def authenticate_user( . . . ): . . . ” or “async def fetch_data( . . . ): . . . ”. The generation unit also attaches a confidence score (e.g., probability value such as 0.92), highlight information for changed parts, and explanatory text for the basis of generation to the output. The confirmation unit inputs the generated source code into static analysis tools (e.g., AST-based bug detection, security vulnerability scanners) and automated test frameworks (e.g., pytest, JUnit, etc.) to evaluate quality. The variation providing unit generates multiple source code proposals by using different generation algorithms (e.g., different temperature parameters, different pre-trained models, different prompt designs) or parameter settings and presents them to the developer. The developer can select the optimal one from these variations and manually modify it as necessary. Automatic generation by AI is not merely automation of human coding work, but realizes fundamentally different technical approaches from conventional human work, such as inference in high-dimensional feature space based on learning from vast past cases, automatic analysis of complex dependencies, and non-idiomatic refactoring proposals. As a result, the system exhibits technical effects such as improved accuracy of workload estimation, reduction of coding errors, shortening of development cycles, and homogenization of source code quality. Application fields include all software development sites, such as web application development, embedded software development, maintenance of financial systems, and continuous delivery of cloud services.

The system according to the embodiment comprises: a reception unit configured to input acceptance conditions; a reception unit configured to input source code of a target system; a generation unit configured to generate source code for modification based on information input by the reception unit; a confirmation unit configured to confirm the source code generated by the generation unit; and a variation providing unit configured to provide a plurality of source code variations generated by the generation unit. The reception unit inputs acceptance conditions. The acceptance conditions may include, for example, functional requirements, non-functional requirements, constraint conditions, but are not limited to such examples. The reception unit inputs source code of the target system. The source code of the target system may include, for example, specific modules, the entire code base, but is not limited to such examples. The generation unit generates source code for modification using AI. The generation unit generates source code for modification using, for example, machine learning, deep learning, natural language processing, and other technologies. The confirmation unit allows a developer to confirm the generated source code and make modifications as necessary. The confirmation unit confirms the generated source code using, for example, code review, test execution, static analysis, and other methods. The variation providing unit provides a plurality of generated source code variations. The variation providing unit provides variations such as different algorithms, different parameter settings, and so on. Thus, the system enables input of acceptance conditions and source code, generation of source code for modification, confirmation, and provision of variations. Specifically, the system can implement each module—reception unit, generation unit, confirmation unit, and variation providing unit—as independent processes or microservices. The system, in the reception unit, receives acceptance conditions (e.g., natural language text, JSON-formatted structured data, tabular data) and source code of the target system (e.g., program files in Python, Java, C++, directory structures, dependency information). The reception unit performs preprocessing of input data, such as tokenization and syntactic analysis of natural language text, conversion of code to abstract syntax tree (AST), and generation of dependency graphs. The generation unit uses, for example, large-scale language models based on Transformer or encoder-decoder neural networks specialized for code generation. The generation unit inputs the acceptance condition text and the AST representation of the source code as multidimensional tensors (e.g., acceptance conditions up to 4096 tokens, source code up to 10,000 tokens in sequence) into the model. Examples of input include acceptance conditions such as “Add user authentication function” or “Make the existing database access part asynchronous,” and corresponding fragments of module source code. The generation unit outputs fragments of source code after modification (e.g., new function definitions, modifications to existing functions, additional comments) as token sequences or file units. Examples of output include “def authenticate_user( . . . ): . . . ” or “async def fetch_data( . . . ): . . . ”. The generation unit also attaches a confidence score (e.g., probability value such as 0.92), highlight information for changed parts, and explanatory text for the basis of generation to the output. The confirmation unit inputs the generated source code into static analysis tools (e.g., AST-based bug detection, security vulnerability scanners) and automated test frameworks (e.g., pytest, JUnit, etc.) to evaluate quality. The variation providing unit generates multiple source code proposals by using different generation algorithms (e.g., different temperature parameters, different pre-trained models, different prompt designs) or parameter settings and presents them to the developer. The developer can select the optimal one from these variations and manually modify it as necessary. Automatic generation by AI is not merely automation of human coding work, but realizes fundamentally different technical approaches from conventional human work, such as inference in high-dimensional feature space based on learning from vast past cases, automatic analysis of complex dependencies, and non-idiomatic refactoring proposals. As a result, the system exhibits technical effects such as improved accuracy of workload estimation, reduction of coding errors, shortening of development cycles, and homogenization of source code quality. Application fields include all software development sites, such as web application development, embedded software development, maintenance of financial systems, and continuous delivery of cloud services.

The generation unit can generate source code for modification using AI. The generation unit generates source code for modification using, for example, machine learning, deep learning, natural language processing, and other technologies. For example, the generation unit can use machine learning algorithms to learn from past source code data and generate new source code for modification. The generation unit can also use deep learning models to learn complex patterns in source code and generate source code for modification. Furthermore, the generation unit can use natural language processing technology to analyze acceptance conditions for tickets and generate source code for modification based on the analysis. Thus, by using AI, the generation unit improves the accuracy of source code generation for modification. Specifically, the generation unit can use large-scale language models based on Transformer architecture or encoder-decoder neural networks specialized for code generation. The generation unit inputs, as input, acceptance condition text (e.g., natural language sentences up to 4096 tokens) and AST representations or dependency graphs of target source code (e.g., code fragments up to 10,000 tokens) as multidimensional tensors into the model. Examples of input include acceptance conditions such as “Add user authentication function” or “Make the database access part asynchronous,” and corresponding fragments of module source code. The generation unit outputs fragments of source code after modification (e.g., new function definitions, modifications to existing functions, additional comments) as token sequences or file units. Examples of output include “def authenticate_user( . . . ): . . . ” or “async def fetch_data( . . . ): . . . ”. The generation unit also attaches a confidence score (e.g., probability value such as 0.92), highlight information for changed parts, and explanatory text for the basis of generation to the output. During training, the generation unit uses cross-entropy or token-level error functions as loss functions and optimizes weight parameters by gradient descent. As data augmentation techniques, the generation unit applies shuffling of code snippets, insertion of comments, randomization of variable names, etc., to improve the generalization performance of the model. During inference, the generation unit uses generation control techniques such as temperature parameters and top-K sampling to obtain diverse outputs. Thus, the generation unit, unlike conventional human coding work, realizes inference in high-dimensional feature space and automatic analysis of complex dependencies, and exhibits technical effects such as improved accuracy of source code generation for modification, error reduction, and improved development efficiency. Application fields include web application development, embedded software development, maintenance of financial systems, and continuous delivery of cloud services.

The confirmation unit allows a developer to confirm the generated source code and make modifications as necessary. The confirmation unit performs, for example, code review. In code review, the developer confirms the generated source code and points out bugs or improvements. The confirmation unit can also perform test execution. In test execution, unit tests and integration tests are executed to confirm whether the generated source code operates correctly. Furthermore, the confirmation unit can perform static analysis. In static analysis, static analysis tools are used to check the quality and security of the generated source code. Thus, by allowing the developer to confirm and modify the generated source code, the confirmation unit improves coding accuracy. Specifically, the confirmation unit inputs the generated source code into AST-based static analysis tools (e.g., bug detectors, security vulnerability scanners) and automated test frameworks (e.g., pytest, JUnit, etc.) to evaluate quality. The confirmation unit outputs the results of static analysis, such as detection results for syntax errors, type mismatches, unused variables, security holes, etc., as structured data (e.g., error lists in JSON format). Examples of output include “line 42: unused variable ‘tmp’” and “type mismatch in function ‘fetch_data’”. The confirmation unit outputs the results of test execution, such as pass/fail judgment for each test case, coverage rate, execution time, etc. Examples of output include “test_authenticate_user: pass” and “coverage rate: 92%”. Based on these output results, the confirmation unit presents modification points and improvements to the developer and prompts manual modification or regeneration as necessary. The confirmation unit records past confirmation history and modification history in a database and can use them as learning data for future quality improvement or automatic correction algorithms. Thus, the confirmation unit, unlike conventional human review work, realizes automatic analysis, evaluation, and history management by computer, and exhibits technical effects such as improved coding accuracy, reduced bug incidence, and shortened development cycles. Application fields include web application development, embedded software development, and maintenance of financial systems.

The variation providing unit can provide a plurality of generated source code variations. The variation providing unit provides, for example, source code variations generated using different algorithms. For example, the variation providing unit provides a plurality of source code variations generated by applying different algorithms to the same modification content. The variation providing unit can also provide source code variations generated using different parameter settings. For example, the variation providing unit provides a plurality of source code variations generated by applying different parameter settings to the same algorithm. Thus, by providing a plurality of source code variations, the variation providing unit enables the developer to select the optimal source code. Specifically, the variation providing unit generates multiple source code proposals output from the generation unit using different generation algorithms (e.g., Transformer-based, RNN-based, rule-based), different temperature parameters, different pre-trained models, and different prompt designs. The variation providing unit attaches a confidence score (e.g., 0.85, 0.92, etc.), highlight information for changed parts, and explanatory text for the basis of generation to each variation. Examples of output include “Variation A: asynchronous function conversion” and “Variation B: addition of lock mechanism”. The variation providing unit provides interactive UI and diff display functions so that developers can compare and evaluate each variation. The variation providing unit can also incorporate an algorithm that automatically recommends the optimal variation based on past selection history and project characteristics. Thus, the variation providing unit, unlike conventional single proposal presentation, provides an environment in which the optimal solution can be selected from diverse generated proposals, and exhibits technical effects such as improved development efficiency, homogenization of quality, and discovery of innovative implementation proposals. Application fields include web application development, embedded software development, and maintenance of financial systems.

The reception unit can input acceptance conditions for tickets. The reception unit inputs, for example, acceptance conditions such as functional requirements, non-functional requirements, and constraint conditions. For example, the reception unit can input the addition or modification of specific functions as functional requirements. The reception unit can also input requirements related to performance or security as non-functional requirements. Furthermore, the reception unit can input specific technical constraints or resource constraints as constraint conditions. Thus, by inputting acceptance conditions for tickets, the reception unit provides basic information for the system to generate source code for modification. Specifically, the reception unit can receive acceptance conditions in various formats, such as natural language text, JSON structured data, and tabular data. The reception unit performs preprocessing such as tokenization, syntactic analysis, and semantic analysis on the input acceptance conditions and converts them into multidimensional tensors (e.g., sequences up to 4096 tokens) that can be understood by the AI model. Examples of input include “Add user authentication function,” “Limit response time to 100 ms or less,” and “Allow communication with external APIs only via HTTPS.” The reception unit is equipped with a history management function for acceptance conditions and can perform automatic completion and candidate suggestion based on past input history. The reception unit can also incorporate an algorithm that dynamically changes input items and input methods according to the progress of the project and user attributes. Thus, the reception unit, unlike conventional static input forms, realizes flexible and efficient input of acceptance conditions and exhibits technical effects such as improved accuracy of source code generation for modification, improved development efficiency, and reduced user burden. Application fields include web application development, embedded software development, and maintenance of financial systems.

The reception unit can input source code of a target system. The reception unit inputs, for example, source code of a target system such as specific modules or the entire code base. For example, by inputting source code of a specific module, the reception unit can generate source code for modification for that module. By inputting the entire code base, the reception unit can also generate source code for modification for the entire system. Thus, by inputting source code of a target system, the reception unit provides basic information for the system to generate source code for modification. Specifically, the reception unit can receive source code of a target system as files, directories, or the entire repository. The reception unit performs preprocessing such as conversion to abstract syntax tree (AST), generation of dependency graphs, and extraction of code metrics on the input source code and converts it into multidimensional tensors (e.g., code fragments up to 10,000 tokens) that can be analyzed by the AI model. Examples of input include “user_module.py,” “entire src directory,” and “code base corresponding to a specific commit ID.” The reception unit also receives version control information and dependency information of the source code, contributing to improved accuracy of modification generation. The reception unit can also incorporate an algorithm that automatically suggests input candidates and input methods based on past input history and project characteristics. Thus, the reception unit, unlike conventional static code input, realizes flexible and efficient input of source code and exhibits technical effects such as improved accuracy of source code generation for modification, improved development efficiency, and reduced user burden. Application fields include web application development, embedded software development, and maintenance of financial systems.

The reception unit can estimate a user's emotion and adjust the method of inputting acceptance conditions based on the estimated emotion of the user. For example, if the user is feeling stressed, the reception unit provides a simple interface and minimizes the input procedure. If the user is relaxed, the reception unit provides detailed input options and proposes customizable input methods. If the user is in a hurry, the reception unit prioritizes voice input to enable quick input of acceptance conditions. Thus, by adjusting the method of inputting acceptance conditions according to the user's emotion, the reception unit reduces the user's burden. Emotion estimation is realized using, for example, an emotion engine or generative AI with emotion estimation functions. Generative AI may be, for example, text generation AI (e.g., LLM) or multimodal generative AI, but is not limited to such examples. Specifically, the reception unit acquires input data consisting of multiple modalities for user emotion estimation, such as facial images, voice waveforms, input text, mouse operation logs, and keystroke patterns. For example, facial images (224×224 pixel RGB image tensors), voice waveforms (1D arrays sampled at 16 kHz), input text (natural language sentences up to 512 tokens), mouse movement coordinate sequences (time series vectors), and keystroke intervals (numerical series) are collected simultaneously. The reception unit performs preprocessing such as normalization, noise removal, and feature extraction (e.g., facial expression feature vectors, voice spectrograms, BERT embeddings, operation speed statistics) on these input data and inputs them into a multimodal emotion estimation model (e.g., a fusion model of image CNN, voice RNN, and text Transformer). The AI model outputs emotion categories (e.g., stress, relaxation, excitement, impatience), emotion intensity scores (continuous values from 0.0 to 1.0), and contribution rates of features as the basis for estimation. Examples of output include “Stress: 0.82,” “Relaxation: 0.15,” and “Voice features are the main factor.” Based on these output results, the reception unit automatically executes subsequent processing such as switching UI layout (e.g., simplifying input items, emphasizing voice input buttons, showing/hiding detailed options), enabling input assistance functions (e.g., auto-completion, history candidate suggestion), and shortening input procedures (e.g., displaying only required items). During training of the emotion estimation model, the reception unit optimizes weights of multimodal feature fusion layers using cross-entropy loss, and during inference, realizes dynamic UI control by combining threshold judgment and heuristic rules. The reception unit records emotion estimation history and input behavior logs in a database and can use them for future personalization and model retraining. Thus, the reception unit, unlike conventional static UI design, dynamically optimizes input methods according to the user's real-time emotional state, and exhibits technical effects such as significant reduction of user burden, reduction of input errors, and improvement of input completion rate. Application fields include ticket management systems in software development sites, customer support inquiry reception, electronic medical record input in medical settings, and learning management systems in education, and can be applied to any field where the user's psychological state affects input efficiency and quality.

The reception unit can analyze a history of past acceptance conditions and propose an optimal input method. For example, the reception unit automatically displays acceptance conditions that the user has frequently input in the past as candidates. The reception unit also preferentially proposes input methods (voice, text, etc.) that the user has used in the past. Furthermore, the reception unit can predict and propose acceptance conditions related to a specific project based on the user's past input history. Thus, by analyzing a history of past acceptance conditions, the reception unit can propose an optimal input method. Specifically, the reception unit maintains an input history database for each user (e.g., structured tables including acceptance condition text, input date and time, input method, project ID, input completion rate, etc.). The reception unit applies algorithms such as time series analysis (e.g., extraction of recent N input trends), frequency analysis (e.g., aggregation of occurrence counts for each condition), and clustering (e.g., grouping of conditions by project or function) to the history data. The reception unit inputs history vectors (e.g., sequences of condition IDs for the past 10 times, one-hot vectors for input methods, project features) into AI models (e.g., time series prediction RNN, Transformer for condition recommendation, classifier for input method selection). Examples of input include “Past 5 times: add user authentication, speed up response, strengthen API constraints,” “Input methods: text, voice, text, text, voice,” etc. The AI model outputs candidate acceptance conditions expected for the next input (e.g., label list with probabilities), recommended input methods (e.g., voice input recommendation score 0.78, text input recommendation score 0.22), and reasons for recommendation (e.g., high-frequency conditions in the past, project similarity). Examples of output include “Candidate: add user authentication (0.65), strengthen API constraints (0.21),” “Recommended input method: voice,” “Reason: voice input in the last 3 times,” etc. Based on these outputs, the reception unit executes subsequent processing such as automatic display of candidate lists in input forms, automatic switching of input method UI, and enabling of auto-completion functions from history. During training of the history analysis algorithm, the reception unit applies reinforcement learning or supervised learning with input completion rate and user satisfaction as objective functions, and continuously improves the personalization performance of the model. Thus, the reception unit, unlike conventional static candidate suggestion or simple history reference, realizes history analysis and dynamic recommendation in multidimensional feature space by AI, and exhibits technical effects such as significant improvement of input efficiency, reduction of input errors, and optimization of user experience. Application fields include ticket management in software development, FAQ input in customer support, medical record input in medical settings, and quality management systems in manufacturing, and can be applied to any business system where input optimization based on history is effective.

The reception unit can dynamically change input items according to the progress of the project when inputting acceptance conditions. For example, in the initial stage of a project, the reception unit allows input of only basic acceptance conditions. In the middle stage of the project, the reception unit allows input of detailed acceptance conditions. In the final stage of the project, the reception unit can also allow input of acceptance conditions for final confirmation. Thus, by dynamically changing input items according to the progress of the project, the reception unit enables appropriate input of acceptance conditions. Specifically, the reception unit acquires the progress status of each project (e.g., start date, milestone achievement rate, remaining task count, progress status, etc.) from project management systems or ticket management databases via API. The reception unit applies input item control algorithms (e.g., rule-based branching, decision trees, progress cluster classifiers) based on progress data (e.g., numerical vectors such as progress rates 0.15, 0.55, 0.95). The reception unit inputs progress feature vectors and past input history into AI models (e.g., LightGBM for progress state classification, Transformer for input item recommendation). Examples of input include “Progress rate 0.10: only basic requirements,” “Progress rate 0.60: detailed requirements +constraint conditions,” “Progress rate 0.95: final confirmation items,” etc. The AI model outputs an optimal input item list for the current progress status (e.g., labeled list of required, recommended, and optional items), input order, and input UI layout proposals. Examples of output include “Initial: functional requirements, non-functional requirements,” “Middle: detailed requirements, constraint conditions,” “Final: confirmation checklist,” etc. Based on these outputs, the reception unit executes subsequent processing such as dynamic generation of input forms, control of item display/hide, and automatic adjustment of input order. The reception unit continuously learns the correspondence between progress status and input items and strengthens personalization according to project characteristics and user behavior. Thus, the reception unit, unlike conventional static input item design, realizes dynamic input control according to project progress, and exhibits technical effects such as prevention of input omissions, improvement of input efficiency, and homogenization of project quality. Application fields include requirements management in software development, progress reporting in construction projects, process management in manufacturing, and progress management in research and development, and can be applied to any field where input optimization according to progress status is required.

The reception unit can estimate a user's emotion and determine the priority of acceptance conditions based on the estimated emotion of the user. For example, if the user is feeling stressed, the reception unit prioritizes input of important acceptance conditions. If the user is relaxed, the reception unit allows input of detailed acceptance conditions. If the user is in a hurry, the reception unit allows input of only the most important acceptance conditions. Thus, by determining the priority of acceptance conditions according to the user's emotion, the reception unit enables prioritized input of important acceptance conditions. Emotion estimation is realized using, for example, an emotion engine or generative AI with emotion estimation functions. Generative AI may be, for example, text generation AI (e.g., LLM) or multimodal generative AI, but is not limited to such examples. Specifically, the reception unit acquires input data consisting of multiple modalities for user emotion estimation, such as facial images, voice, input text, and operation logs (e.g., facial images 224×224 pixels, voice waveforms 16 kHz, text up to 512 tokens, mouse movement coordinate sequences), and performs preprocessing (normalization, feature extraction) before inputting them into a multimodal emotion estimation model (e.g., image CNN+voice RNN+text Transformer). The AI model outputs emotion categories (e.g., stress, relaxation, impatience), emotion intensity scores (0.0-1.0), and feature quantities as the basis for estimation. Examples of output include “Stress: 0.85,” “Relaxation: 0.10,” “Voice features are the main factor.” The reception unit assigns importance scores (e.g., weights based on project characteristics and past input history) to the acceptance condition list (e.g., functional requirements, non-functional requirements, constraint conditions, etc.), and applies a priority determination algorithm (e.g., weighted sorting, threshold judgment) in combination with emotion estimation results. The reception unit outputs a prioritized input item list (e.g., only required items during stress, all items during relaxation, only the most important items when in a hurry), and controls the display of the input UI and automatically adjusts the input order. The reception unit records emotion estimation history and input behavior logs in a database and can use them for future personalization and model retraining. Thus, the reception unit, unlike conventional static input order or uniform item presentation, dynamically optimizes input priorities according to the user's real-time emotional state, and exhibits technical effects such as prevention of omission of important items, improvement of input efficiency, and reduction of user burden. Application fields include requirements management in software development, medical questionnaire input in medical settings, and inquiry reception in customer support, and can be applied to any field where control of input item priority is effective.

The reception unit can preferentially input highly relevant conditions by considering the user's geographic location information when inputting acceptance conditions. For example, if the user is in a specific region, the reception unit prioritizes input of acceptance conditions related to that region. If the user is moving, the reception unit prioritizes input of acceptance conditions related to the destination. If the user is involved in a specific project, the reception unit can also prioritize input of acceptance conditions related to that project. Thus, by considering the user's geographic location information, the reception unit enables prioritized input of highly relevant acceptance conditions. Specifically, the reception unit acquires geographic location information (e.g., latitude and longitude coordinates, region codes, country/city names) in real time from the user's device via GPS, Wi-Fi, IP address, etc. The reception unit calculates relevance scores (e.g., region match degree, destination prediction probability, project relevance) by referencing a geographic condition database (e.g., region-specific regulations, local requirements, project base information) based on location information. The reception unit inputs current location, movement history, and project attribute vectors into AI models (e.g., classifier for condition recommendation based on location information, neural network with geographic features as input). Examples of input include “Current location: Chiyoda-ku, Tokyo,” “Destination: Osaka City,” “Project: Kansai base,” etc. The AI model outputs a list of acceptance conditions to be prioritized (e.g., region-specific security requirements, local regulations, base-specific operational rules), priority scores, and reasons for recommendation. Examples of output include “Priority: API constraints for Kansai base (0.92),” “Reason: destination is Osaka City,” etc. Based on these outputs, the reception unit executes subsequent processing such as automatic display of candidate lists in input forms, application of region-specific templates, and automatic sorting of input items. The reception unit continuously learns personalization algorithms that combine geographic location information and input history to provide optimal input experiences for each user. Thus, the reception unit, unlike conventional uniform input item presentation, dynamically prioritizes and displays highly relevant conditions according to the user's current location and movement status, and exhibits technical effects such as improved input efficiency, prevention of omission of regional requirements, and homogenization of project quality. Application fields include global software development, financial and medical systems requiring compliance with local regulations, and site management in logistics and transportation industries, and can be applied to any field where geographic requirements are important.

The reception unit can analyze a user's social media activity when inputting acceptance conditions and propose relevant conditions. For example, the reception unit proposes acceptance conditions related to projects mentioned by the user on social media. The reception unit also proposes acceptance conditions based on information shared by the user on social media. Furthermore, the reception unit can propose acceptance conditions related to specific topics based on the user's social media activity. Thus, by analyzing the user's social media activity, the reception unit can propose relevant acceptance conditions. Specifically, the reception unit acquires the user's public social media post data (e.g., text posts, images, hashtags, post date and time, location-tagged posts) via API and analyzes the content using natural language processing engines and image analysis modules. For text posts, the reception unit performs preprocessing such as tokenization, named entity extraction, topic clustering, and sentiment analysis, and for image posts, applies image classification models and object detection models to convert the content into feature vectors. The reception unit integrates these features as multidimensional vectors (e.g., 512-dimensional embeddings for post text, 2048-dimensional image feature vectors, one-hot vectors for hashtags) and inputs them into AI models (e.g., Transformer-based topic estimation models, neural networks for condition recommendation). Examples of input include “#ProjectX,” “API security enhancement,” “Image: design drawing,” etc. The AI model outputs highly relevant acceptance condition candidates (e.g., API authentication enhancement, mandatory design review, addition of specific functions), relevance scores (0.0-1.0), and reasons for recommendation (e.g., posting frequency, topic match degree, relevance to image content). Examples of output include “API authentication enhancement (0.88): from #ProjectX post,” “Mandatory design review (0.75): from image analysis result,” etc. Based on these outputs, the reception unit executes subsequent processing such as automatic display of candidate lists in input forms, automatic application of condition templates, and sorting of input items. The reception unit continuously learns the correspondence between social media activity and acceptance conditions and can incorporate algorithms to personalize condition recommendations for each user. Thus, the reception unit, unlike conventional static condition input or simple history reference, dynamically utilizes social media as an external information source to realize acceptance condition proposals that reflect the user's interests and the latest project trends in real time, and exhibits technical effects such as improved input efficiency, prevention of omission of conditions, and homogenization of project quality. Application fields include requirements management in software development, extraction of requirements for marketing measures, automatic generation of FAQs in customer support, and curriculum design in education, and can be applied to any field where the user's external activities affect business requirements.

The reception unit can estimate a user's emotion and adjust the method of inputting source code based on the estimated emotion of the user. For example, if the user is feeling stressed, the reception unit provides a simple interface and minimizes the input procedure. If the user is relaxed, the reception unit provides detailed input options and proposes customizable input methods. If the user is in a hurry, the reception unit prioritizes voice input to enable quick input of source code. Thus, by adjusting the method of inputting source code according to the user's emotion, the reception unit reduces the user's burden. Emotion estimation is realized using, for example, an emotion engine or generative AI with emotion estimation functions. Generative AI may be, for example, text generation AI (e.g., LLM) or multimodal generative AI, but is not limited to such examples. Specifically, the reception unit simultaneously acquires input data consisting of multiple modalities for user emotion estimation, such as facial images (224×224 pixel RGB image tensors), voice waveforms (1D arrays sampled at 16 kHz), input text (natural language sentences up to 512 tokens), mouse operation logs (time series vectors), and keystroke intervals (numerical series). The reception unit performs preprocessing such as normalization, noise removal, and feature extraction (e.g., facial expression feature vectors, voice spectrograms, BERT embeddings, operation speed statistics) on these input data and inputs them into a multimodal emotion estimation model (e.g., a fusion model of image CNN, voice RNN, and text Transformer). The AI model outputs emotion categories (e.g., stress, relaxation, excitement, impatience), emotion intensity scores (continuous values from 0.0 to 1.0), and contribution rates of features as the basis for estimation. Examples of output include “Stress: 0.82,” “Relaxation: 0.15,” and “Voice features are the main factor.” Based on these output results, the reception unit automatically executes subsequent processing such as switching UI layout (e.g., simplifying input items, emphasizing voice input buttons, showing/hiding detailed options), enabling input assistance functions (e.g., auto-completion, history candidate suggestion), and shortening input procedures (e.g., displaying only required items). During training of the emotion estimation model, the reception unit optimizes weights of multimodal feature fusion layers using cross-entropy loss, and during inference, realizes dynamic UI control by combining threshold judgment and heuristic rules. The reception unit records emotion estimation history and input behavior logs in a database and can use them for future personalization and model retraining. Thus, the reception unit, unlike conventional static UI design, dynamically optimizes input methods according to the user's real-time emotional state, and exhibits technical effects such as significant reduction of user burden, reduction of input errors, and improvement of input completion rate. Application fields include ticket management systems in software development sites, customer support inquiry reception, electronic medical record input in medical settings, and learning management systems in education, and can be applied to any field where the user's psychological state affects input efficiency and quality.

The reception unit can analyze a history of past source code input and propose an optimal input method. For example, the reception unit automatically displays source code that the user has frequently input in the past as candidates. The reception unit also preferentially proposes input methods (voice, text, etc.) that the user has used in the past. Furthermore, the reception unit can predict and propose source code related to a specific project based on the user's past input history. Thus, by analyzing a history of past source code input, the reception unit can propose an optimal input method. Specifically, the reception unit maintains an input history database for each user (e.g., structured tables including source code fragments, input date and time, input method, project ID, input completion rate, etc.). The reception unit applies algorithms such as time series analysis (e.g., extraction of recent N input trends), frequency analysis (e.g., aggregation of occurrence counts for each code fragment), and clustering (e.g., grouping of code by project or function) to the history data. The reception unit inputs history vectors (e.g., sequences of code IDs for the past 10 times, one-hot vectors for input methods, project features) into AI models (e.g., time series prediction RNN, Transformer for code recommendation, classifier for input method selection). Examples of input include “Past 5 times: user_module.py, add auth function, strengthen API constraints,” “Input methods: text, voice, text, text, voice,” etc. The AI model outputs candidate source code expected for the next input (e.g., label list with probabilities), recommended input methods (e.g., voice input recommendation score 0.78, text input recommendation score 0.22), and reasons for recommendation (e.g., high-frequency code in the past, project similarity). Examples of output include “Candidate: add auth function (0.65), strengthen API constraints (0.21),” “Recommended input method: voice,” “Reason: voice input in the last 3 times,” etc. Based on these outputs, the reception unit executes subsequent processing such as automatic display of candidate lists in input forms, automatic switching of input method UI, and enabling of auto-completion functions from history. During training of the history analysis algorithm, the reception unit applies reinforcement learning or supervised learning with input completion rate and user satisfaction as objective functions, and continuously improves the personalization performance of the model. Thus, the reception unit, unlike conventional static candidate suggestion or simple history reference, realizes history analysis and dynamic recommendation in multidimensional feature space by AI, and exhibits technical effects such as significant improvement of input efficiency, reduction of input errors, and optimization of user experience. Application fields include ticket management in software development, FAQ input in customer support, medical record input in medical settings, and quality management systems in manufacturing, and can be applied to any business system where input optimization based on history is effective.

The reception unit can dynamically change input items according to the progress of the project when inputting source code. For example, in the initial stage of a project, the reception unit allows input of only basic source code. In the middle stage of the project, the reception unit allows input of detailed source code. In the final stage of the project, the reception unit can also allow input of source code for final confirmation. Thus, by dynamically changing input items according to the progress of the project, the reception unit enables appropriate input of source code. Specifically, the reception unit acquires the progress status of each project (e.g., start date, milestone achievement rate, remaining task count, progress status, etc.) from project management systems or ticket management databases via API. The reception unit applies input item control algorithms (e.g., rule-based branching, decision trees, progress cluster classifiers) based on progress data (e.g., numerical vectors such as progress rates 0.15, 0.55, 0.95). The reception unit inputs progress feature vectors and past input history into AI models (e.g., LightGBM for progress state classification, Transformer for input item recommendation). Examples of input include “Progress rate 0.10: only basic modules,” “Progress rate 0.60: detailed functions+constraint conditions,” “Progress rate 0.95: code for final confirmation,” etc. The AI model outputs an optimal input item list for the current progress status (e.g., labeled list of required, recommended, and optional items), input order, and input UI layout proposals. Examples of output include “Initial: user_module.py,” “Middle: add auth function, strengthen API constraints,” “Final: code for final confirmation,” etc. Based on these outputs, the reception unit executes subsequent processing such as dynamic generation of input forms, control of item display/hide, and automatic adjustment of input order. The reception unit continuously learns the correspondence between progress status and input items and strengthens personalization according to project characteristics and user behavior. Thus, the reception unit, unlike conventional static input item design, realizes dynamic input control according to project progress, and exhibits technical effects such as prevention of input omissions, improvement of input efficiency, and homogenization of project quality. Application fields include requirements management in software development, progress reporting in construction projects, process management in manufacturing, and progress management in research and development, and can be applied to any field where input optimization according to progress status is required.

The reception unit can estimate a user's emotion and determine the priority of source code based on the estimated emotion of the user. For example, if the user is feeling stressed, the reception unit prioritizes input of important source code. If the user is relaxed, the reception unit allows input of detailed source code. If the user is in a hurry, the reception unit allows input of only the most important source code. Thus, by determining the priority of source code according to the user's emotion, the reception unit enables prioritized input of important source code. Emotion estimation is realized using, for example, an emotion engine or generative AI with emotion estimation functions. Generative AI may be, for example, text generation AI (e.g., LLM) or multimodal generative AI, but is not limited to such examples. Specifically, the reception unit acquires input data consisting of multiple modalities for user emotion estimation, such as facial images, voice, input text, and operation logs (e.g., facial images 224×224 pixels, voice waveforms 16 kHz, text up to 512 tokens, mouse movement coordinate sequences), and performs preprocessing (normalization, feature extraction) before inputting them into a multimodal emotion estimation model (e.g., image CNN+voice RNN+text Transformer). The AI model outputs emotion categories (e.g., stress, relaxation, impatience), emotion intensity scores (0.0-1.0), and feature quantities as the basis for estimation. Examples of output include “Stress: 0.85,” “Relaxation: 0.10,” “Voice features are the main factor.” The reception unit assigns importance scores (e.g., weights based on project characteristics and past input history) to the source code list (e.g., function addition, bug fix, constraint handling, etc.), and applies a priority determination algorithm (e.g., weighted sorting, threshold judgment) in combination with emotion estimation results. The reception unit outputs a prioritized input item list (e.g., only required items during stress, all items during relaxation, only the most important items when in a hurry), and controls the display of the input UI and automatically adjusts the input order. The reception unit records emotion estimation history and input behavior logs in a database and can use them for future personalization and model retraining. Thus, the reception unit, unlike conventional static input order or uniform item presentation, dynamically optimizes input priorities according to the user's real-time emotional state, and exhibits technical effects such as prevention of omission of important items, improvement of input efficiency, and reduction of user burden. Application fields include requirements management in software development, medical questionnaire input in medical settings, and inquiry reception in customer support, and can be applied to any field where control of input item priority is effective.

The reception unit can preferentially input highly relevant code by considering the user's geographic location information when inputting source code. For example, if the user is in a specific region, the reception unit prioritizes input of source code related to that region. If the user is moving, the reception unit prioritizes input of source code related to the destination. If the user is involved in a specific project, the reception unit can also prioritize input of source code related to that project. Thus, by considering the user's geographic location information, the reception unit enables prioritized input of highly relevant source code. Specifically, the reception unit acquires geographic location information (e.g., latitude and longitude coordinates, region codes, country/city names) in real time from the user's device via GPS, Wi-Fi, IP address, etc. The reception unit calculates relevance scores (e.g., region match degree, destination prediction probability, project relevance) by referencing a geographic condition database (e.g., region-specific regulations, local requirements, project base information) based on location information. The reception unit inputs current location, movement history, and project attribute vectors into AI models (e.g., classifier for code recommendation based on location information, neural network with geographic features as input). Examples of input include “Current location: Chiyoda-ku, Tokyo,” “Destination: Osaka City,” “Project: Kansai base,” etc. The AI model outputs a list of source code to be prioritized (e.g., region-specific security requirements, local regulations, base-specific operational rules), priority scores, and reasons for recommendation. Examples of output include “Priority: API constraints for Kansai base (0.92),” “Reason: destination is Osaka City,” etc. Based on these outputs, the reception unit executes subsequent processing such as automatic display of candidate lists in input forms, application of region-specific templates, and automatic sorting of input items. The reception unit continuously learns personalization algorithms that combine geographic location information and input history to provide optimal input experiences for each user. Thus, the reception unit, unlike conventional uniform input item presentation, dynamically prioritizes and displays highly relevant code according to the user's current location and movement status, and exhibits technical effects such as improved input efficiency, prevention of omission of regional requirements, and homogenization of project quality. Application fields include global software development, financial and medical systems requiring compliance with local regulations, and site management in logistics and transportation industries, and can be applied to any field where geographic requirements are important.

The reception unit can analyze a user's social media activity when inputting source code and propose relevant code. For example, the reception unit proposes source code related to projects mentioned by the user on social media. The reception unit also proposes source code based on information shared by the user on social media. Furthermore, the reception unit can propose source code related to specific topics based on the user's social media activity. Thus, by analyzing the user's social media activity, the reception unit can propose relevant source code. Specifically, the reception unit acquires the user's public social media post data (e.g., text posts, images, hashtags, post date and time, location-tagged posts) via API and analyzes the content using natural language processing engines and image analysis modules. For text posts, the reception unit performs preprocessing such as tokenization, named entity extraction, topic clustering, and sentiment analysis, and for image posts, applies image classification models and object detection models to convert the content into feature vectors. The reception unit integrates these features as multidimensional vectors (e.g., 512-dimensional embeddings for post text, 2048-dimensional image feature vectors, one-hot vectors for hashtags) and inputs them into AI models (e.g., Transformer-based topic estimation models, neural networks for code recommendation). Examples of input include “#ProjectX,” “API security enhancement,” “Image: design drawing,” etc. The AI model outputs highly relevant source code candidates (e.g., API authentication enhancement, mandatory design review, addition of specific functions), relevance scores (0.0-1.0), and reasons for recommendation (e.g., posting frequency, topic match degree, relevance to image content). Examples of output include “API authentication enhancement (0.88): from #ProjectX post,” “Mandatory design review (0.75): from image analysis result,” etc. Based on these outputs, the reception unit executes subsequent processing such as automatic display of candidate lists in input forms, automatic application of code templates, and sorting of input items. The reception unit continuously learns the correspondence between social media activity and source code and can incorporate algorithms to personalize code recommendations for each user. Thus, the reception unit, unlike conventional static code input or simple history reference, dynamically utilizes social media as an external information source to realize source code proposals that reflect the user's interests and the latest project trends in real time, and exhibits technical effects such as improved input efficiency, prevention of omission of code, and homogenization of project quality. Application fields include requirements management in software development, extraction of requirements for marketing measures, automatic generation of FAQs in customer support, and curriculum design in education, and can be applied to any field where the user's external activities affect business requirements.

The generation unit is capable of estimating a user's emotion and adjusting the method of expressing the generated source code based on the estimated emotion. For example, when the user is relaxed, the generation unit generates source code that progresses at a leisurely pace. When the user is in a hurry, the generation unit generates source code that emphasizes the shortest route. Additionally, when the user is excited, the generation unit can generate source code with visually stimulating effects. By adjusting the method of expressing the source code according to the user's emotion, the generation unit can generate source code that is easier for the user to understand. Emotion estimation is realized, for example, by using an emotion estimation function with an emotion engine or a generation AI. The generation AI may be a text generation AI (e.g., LLM) or a multimodal generation AI, but is not limited to these examples. Specifically, the generation unit receives the user's emotion estimation result (e.g., category labels such as stress, relaxation, excitement, hurry, and an emotion intensity score from 0.0 to 1.0) from the reception unit as input parameters. For emotion estimation, the generation unit obtains multimodal data via the reception unit, such as facial images (224×224 pixel RGB image tensor), audio waveforms (1D array sampled at 16 kHz), input text (up to 512 tokens), mouse operation logs (time-series vectors), and keystroke intervals (numerical series), and utilizes emotion categories and intensity scores estimated by a multimodal emotion estimation model (e.g., a fusion model of image CNN, audio RNN, and text Transformer). The generation unit incorporates this emotion information into prompts or control tokens for a large language model for source code generation (e.g., a Transformer-based encoder-decoder neural network). For example, in a relaxed state, the generation unit generates source code with detailed comments and stepwise processing flows that emphasize readability. In a hurried state, the generation unit generates source code that highlights efficient algorithms and shortcut processing that meet functional requirements with minimal description. In an excited state, the generation unit generates code fragments with visually stimulating effects, such as UI code with animations and color effects, or log output with highlights. As input, the generation unit receives acceptance condition text (up to 4096 tokens), AST representation of the target source code (up to 10,000 tokens), and emotion category/intensity scores as multidimensional tensors. Example inputs include “Add user authentication function” “Emotion: Relaxed (0.80)” or “Strengthen API constraints” “Emotion: Hurry (0.92)”. As output, the generation unit generates modified source code fragments (e.g., new function definitions, modifications to existing functions, additional comments) as token sequences or file units, and further attaches metadata such as the method of expression of the generated code (e.g., amount of comments, stepwise processing flow, presence or absence of effect descriptions). Example outputs include “def authenticate_user( . . . ): . . . #This function . . . ” or “async def fetch_data( . . . ): . . . #Fetch data via shortest route”. During generation, the generation unit uses temperature parameters, top-K sampling, and control tokens (e.g., #EMOTION_RELAXED, #EMOTION_HURRY) to achieve emotion-based generation control. During training, the generation unit uses a code corpus labeled with emotions to perform supervised learning of the correspondence between emotions and code expression, and optimizes weights by combining cross-entropy and emotion matching loss as the loss function. The generation unit attaches a confidence score, explanation of generation rationale, and emotion fit evaluation to the generation result, and links to the subsequent confirmation unit and variation providing unit. Unlike conventional uniform code generation, the generation unit dynamically optimizes code expression according to the user's real-time emotional state, thereby achieving technical effects such as improved user comprehension, increased work efficiency, and reduced psychological burden. Application fields include ticket management systems in software development, programming learning support in education, automatic response systems in customer support, and electronic medical record input assistance in medical settings, and can be applied to any field where the user's psychological state affects code comprehension and work efficiency.

The generation unit is capable of adjusting the level of detail of generation based on the importance of the modification at the time of generation. For example, when the modification is important, the generation unit generates detailed source code. When the modification is of low importance, the generation unit generates simplified source code. Additionally, the generation unit can add comments or explanations to the generated source code according to the importance of the modification. Thus, the generation unit can adjust the level of detail of the generated source code according to the importance of the modification. Specifically, the generation unit uses the importance score for each modification (e.g., a continuous value from 0.0 to 1.0 or category labels such as “high,” “medium,” “low”) received from the reception unit as input parameters. The generation unit incorporates the importance score into prompts or control tokens for a large language model for source code generation (e.g., a Transformer-based encoder-decoder neural network). For example, when the importance is high, the generation unit generates source code including detailed processing flows, exception handling, input validation, logging, security measures, and detailed comments or documentation. When the importance is low, the generation unit generates concise code implementing only the main functions, or code with minimal comments. As input, the generation unit receives acceptance condition text (up to 4096 tokens), AST representation of the target source code (up to 10,000 tokens), and importance score as multidimensional tensors. Example inputs include “Bug fix (importance: high)” or “UI fine-tuning (importance: low)”. As output, the generation unit generates modified source code fragments (e.g., new function definitions, modifications to existing functions, additional comments) as token sequences or file units, and attaches metadata such as the level of detail of the generated code (e.g., number of comment lines, presence of exception handling, presence of documentation generation). Example outputs include “def authenticate_user( . . . ): . . . #With input validation, exception handling, and detailed comments” or “def minor_ui_fix( . . . ): . . . #Simple fix”. During generation, the generation unit uses temperature parameters and control tokens (e.g., #DETAIL_HIGH, #DETAIL_LOW) to control the level of detail. During training, the generation unit uses a code corpus labeled with importance to perform supervised learning of the correspondence between importance and code detail level, and optimizes weights by combining cross-entropy and detail matching loss as the loss function. The generation unit attaches a confidence score, explanation of generation rationale, and detail evaluation to the generation result, and links to the subsequent confirmation unit and variation providing unit. Unlike conventional uniform code generation, the generation unit dynamically optimizes code detail level according to the importance of the modification, thereby achieving technical effects such as improved quality of important modifications, increased review efficiency, reduced risk, and optimal allocation of development resources. Application fields include security fixes for financial systems, addition of critical functions to medical systems, UI improvements for web services, and any field where the importance of modifications is directly linked to quality and risk.

The generation unit is capable of applying different generation algorithms according to the category of the modification at the time of generation. For example, in the case of bug fixes, the generation unit applies a generation algorithm specialized for bug fixes. In the case of new feature additions, the generation unit applies a generation algorithm specialized for new feature additions. Additionally, in the case of performance improvements, the generation unit can apply a generation algorithm specialized for performance improvements. Thus, the generation unit can apply the optimal generation algorithm according to the category of the modification. Specifically, the generation unit uses the modification category (e.g., labels such as “bug fix,” “new feature addition,” “performance improvement,” “security enhancement”) received from the reception unit as input parameters. The generation unit internally maintains multiple generation algorithms optimized for each category (e.g., rule-based and pattern-matching models for bug fixes, large language models for new feature additions, reinforcement learning models and optimization algorithms for performance improvements), and selects and applies the appropriate model according to category determination. For example, in the case of bug fixes, the generation unit uses a pattern-matching and fix template application algorithm trained on past bug fix case datasets to detect bug patterns in existing code and generate fixes. For new feature additions, the generation unit uses an encoder-decoder neural network that takes acceptance condition text and AST representation of existing code as input to generate new functions, classes, or interface extensions. For performance improvements, the generation unit uses code metrics and profiling information as input, and applies bottleneck detection algorithms or reinforcement learning-based optimization models to generate optimization proposals such as asynchronization, cache introduction, or algorithm replacement. As input, the generation unit receives acceptance condition text, AST representation of the target source code, and category labels as multidimensional tensors. Example inputs include “Bug fix: NullPointerException handling,” “New feature addition: user authentication function,” or “Performance improvement: DB access acceleration.” As output, the generation unit generates modified source code fragments according to the category (e.g., bug fix patches, new functions, optimized code), and attaches metadata such as generation rationale and applied algorithm information. Example outputs include “if obj is not None: . . . #Added null check,” “def authenticate_user( . . . ): . . . #New authentication function,” or “async def fetch_data( . . . ): . . . #Asynchronous processing.” The generation unit can also combine model selection logic and ensemble methods for each category to integrate outputs from multiple models. Unlike conventional uniform code generation by a single model, the generation unit dynamically applies the optimal algorithm according to the category of the modification, thereby achieving technical effects such as improved generation accuracy, faster bug fixes, increased flexibility in new feature additions, and automation of performance optimization. Application fields include general software development, especially maintenance and expansion of large-scale systems, and mission-critical system modifications in finance, healthcare, and manufacturing, where category-specific optimization is required.

The generation unit is capable of estimating a user's emotion and adjusting the length of the generated source code based on the estimated emotion. For example, when the user is in a hurry, the generation unit generates short source code that covers the main points. When the user is relaxed, the generation unit generates longer source code with detailed explanations. Additionally, when the user is excited, the generation unit can generate source code with visually stimulating effects. By adjusting the length of the source code according to the user's emotion, the generation unit can generate source code of an appropriate length for the user. Emotion estimation is realized, for example, by using an emotion estimation function with an emotion engine or a generation AI. The generation AI may be a text generation AI (e.g., LLM) or a multimodal generation AI, but is not limited to these examples. Specifically, the generation unit uses the user's emotion estimation result (e.g., category label and intensity score) received from the reception unit as input parameters, and incorporates them into prompts or control tokens for a large language model for source code generation. The generation unit applies algorithms that control the length (e.g., number of lines, amount of comments, presence of explanations) and level of detail of the generated code for each emotion category. For example, when in a hurry, the generation unit generates short code that describes only the main processing, or output with minimal comments. When relaxed, the generation unit generates longer code with detailed explanatory comments, stepwise processing flows, and supplementary documentation. When excited, the generation unit generates code that emphasizes visual elements, such as adding animation or effect descriptions to UI code. As input, the generation unit receives acceptance condition text, AST representation of the target source code, and emotion category/intensity score as multidimensional tensors. Example inputs include “Strengthen API constraints” “Emotion: Hurry (0.92)” or “UI improvement” “Emotion: Relaxed (0.80)”. As output, the generation unit generates source code fragments of length and detail appropriate to the emotion, and attaches metadata such as number of lines, amount of comments, and presence of effects to the generated code. Example outputs include “def fetch_data( . . . ): . . . #Minimal processing” or “def authenticate_user( . . . ): . . . #With detailed explanation”. During generation, the generation unit uses length control parameters (e.g., max_length, min_length) and control tokens (e.g., #LENGTH_SHORT, #LENGTH_LONG) to adjust output length. During training, the generation unit uses a code corpus labeled with emotions to perform supervised learning of the correspondence between emotions and code length/detail, and optimizes weights by combining length matching loss as the loss function. The generation unit attaches a confidence score, explanation of generation rationale, and length fit evaluation to the generation result, and links to the subsequent confirmation unit and variation providing unit. Unlike conventional uniform code length output, the generation unit dynamically optimizes code length according to the user's real-time emotional state, thereby achieving technical effects such as improved work efficiency, increased comprehension, and reduced psychological burden. Application fields include ticket management systems in software development, programming learning support in education, automatic response systems in customer support, and electronic medical record input assistance in medical settings, and can be applied to any field where the user's psychological state affects code comprehension and work efficiency.

The generation unit is capable of determining the priority of generation based on the submission timing of the modification at the time of generation. For example, when the deadline for a modification is near, the generation unit generates source code with priority. When the submission timing for a modification is far, the generation unit generates source code later. Additionally, the generation unit can adjust the level of detail of the generated source code according to the submission timing. Thus, the generation unit can determine the priority of the generated source code according to the submission timing of the modification. Specifically, the generation unit uses submission timing information for each modification (e.g., submission deadline date and time, remaining days, priority score) received from the reception unit as input parameters. The generation unit prioritizes modifications with near submission timing by queuing them, and automatically determines the order of generation processing using an internal priority task scheduler (e.g., priority queue, scheduling algorithm). When the submission timing is near, the generation unit adjusts the level of detail to prioritize rapid generation, and when the submission timing is far, the generation unit generates high-quality code with detailed comments and documentation. As input, the generation unit receives acceptance condition text, AST representation of the target source code, and submission timing information as multidimensional tensors. Example inputs include “Bug fix: submission deadline 2024 Jul. 1” or “New feature addition: submission deadline 2024 Aug. 15”. As output, the generation unit outputs source code fragments generated with priority according to submission timing, and attaches metadata such as generation order and level of detail. Example outputs include “def urgent_fix( . . . ): . . . #Deadline response” or “def future_feature( . . . ): . . . #Detailed design”. The generation unit can apply scheduling algorithms such as priority round-robin, shortest remaining time first (SRTF), and weighted fair queuing. The generation unit continuously learns the correspondence between submission timing and generation detail level, and strengthens personalization based on historical data. Unlike conventional uniform generation order and detail output, the generation unit achieves dynamic priority control and detail optimization according to submission timing, thereby achieving technical effects such as improved deadline compliance rate, optimal allocation of development resources, and balancing quality and speed. Application fields include sprint management in agile development, emergency patch response in operations and maintenance, milestone management in research and development, and any field where submission timing is directly linked to quality and deadlines.

The generation unit is capable of adjusting the order of generation based on the relevance of the modification at the time of generation. For example, the generation unit generates source code for highly relevant modifications with priority. For modifications with low relevance, the generation unit generates source code later. Additionally, the generation unit can adjust the order of the generated source code according to the relevance of the modification. Thus, the generation unit can adjust the order of the generated source code according to the relevance of the modification. Specifically, the generation unit uses relevance scores between modifications (e.g., continuous values from 0.0 to 1.0, dependency graphs, cluster IDs) received from the reception unit as input parameters. The generation unit constructs a dependency graph between modifications, groups highly relevant modifications using topological sorting or clustering algorithms, and prioritizes generation processing for these groups. For example, if addition of function A and modification of function B are strongly related, the generation unit generates code in the order of function A→function B, achieving consistent output that considers dependencies. As input, the generation unit receives acceptance condition text, AST representation of the target source code, and relevance scores or dependency graphs as multidimensional tensors. Example inputs include “Add function A (related: modify function B)” or “Modify function C (independent)”. As output, the generation unit outputs source code fragments generated in order according to relevance, and attaches metadata such as generation order and dependency information. Example outputs include “def add_feature_a( . . . ): . . . ” or “def modify_feature_b( . . . ): . . . ”. The generation unit applies priority queues and dependency resolution algorithms (e.g., topological sorting, clustering) based on relevance scores to optimize generation order. The generation unit continuously learns the correspondence between relevance and generation order, and strengthens personalization based on historical data. Unlike conventional uniform generation order or independent processing, the generation unit dynamically analyzes and reflects the relevance of modifications, thereby achieving technical effects such as ensuring consistency between functions, reducing bug introduction rate, and improving development efficiency. Application fields include addition and modification of functions in large-scale systems, simultaneous modification of multiple modules, and maintenance of business systems with complex dependencies, and can be applied to any field where the relevance of modifications is directly linked to quality and efficiency.

The confirmation unit is capable of estimating a user's emotion and adjusting the method of confirmation based on the estimated emotion. For example, when the user feels stressed, the confirmation unit provides a simple confirmation method and minimizes the confirmation procedure. When the user is relaxed, the confirmation unit provides detailed confirmation options and proposes customizable confirmation methods. Additionally, when the user is in a hurry, the confirmation unit can provide methods for rapid confirmation. By adjusting the confirmation method according to the user's emotion, the confirmation unit can provide an appropriate confirmation method for the user. Emotion estimation is realized, for example, by using an emotion estimation function with an emotion engine or a generation AI. The generation AI may be a text generation AI (e.g., LLM) or a multimodal generation AI, but is not limited to these examples. Specifically, the confirmation unit uses the user's emotion estimation result (e.g., category labels such as stress, relaxation, excitement, hurry, and an emotion intensity score from 0.0 to 1.0) received from the reception unit as input parameters. For emotion estimation, the confirmation unit obtains multimodal data via the reception unit, such as facial images (224×224 pixel RGB image tensor), audio waveforms (1D array sampled at 16 kHz), input text (up to 512 tokens), mouse operation logs (time-series vectors), and keystroke intervals (numerical series), and utilizes emotion categories and intensity scores estimated by a multimodal emotion estimation model (e.g., a fusion model of image CNN, audio RNN, and text Transformer). The confirmation unit incorporates this emotion information into confirmation procedure control algorithms (e.g., rule-based branching, decision trees, emotion state classifiers) and UI control modules as input parameters. For example, in a stress state, the confirmation unit automatically generates a simple UI that displays only required items and minimizes confirmation procedures. In a relaxed state, the confirmation unit enables detailed confirmation options (e.g., additional checklists, detailed log display, customizable confirmation flows) so that the user can freely select confirmation procedures. In a hurried state, the confirmation unit prioritizes interfaces that allow rapid operations, such as voice input or one-click confirmation. According to the emotion estimation result, the confirmation unit executes subsequent processing such as display/hide control of confirmation items, automatic adjustment of confirmation order, and enabling auxiliary functions (e.g., automatic error correction suggestions, history reference). The confirmation unit records emotion estimation history and confirmation behavior logs in a database, which can be used for future personalization and model retraining. Unlike conventional static confirmation procedure design, the confirmation unit dynamically optimizes confirmation methods according to the user's real-time emotional state, thereby achieving technical effects such as significant reduction of user burden, reduction of confirmation errors, and improvement of confirmation completion rate. Application fields include code review systems in software development, confirmation of diagnostic results in medical settings, audit checklists in financial systems, and assignment submission confirmation in education, and can be applied to any field where the user's psychological state affects confirmation efficiency and quality.

The confirmation unit is capable of referring to past confirmation history at the time of confirmation to propose the optimal confirmation method. For example, the confirmation unit preferentially proposes confirmation methods that the user has frequently used in the past. The confirmation unit can also propose confirmation methods related to a specific project based on the user's past confirmation history. Additionally, the confirmation unit can analyze the user's past confirmation history to propose the most efficient confirmation method. Thus, by referring to past confirmation history, the confirmation unit can propose the optimal confirmation method. Specifically, the confirmation unit maintains a confirmation history database for each user (e.g., a structured table including confirmation method ID, confirmation date and time, project ID, confirmation completion rate, confirmation time required, confirmation result, etc.). The confirmation unit applies algorithms such as time-series analysis (e.g., extraction of recent N confirmation trends), frequency analysis (e.g., aggregation of usage count for each confirmation method), and clustering (e.g., grouping by project or function) to the history data. The confirmation unit inputs history vectors (e.g., sequence of confirmation method IDs for the past 10 confirmations, project features, confirmation time vectors) into AI models (e.g., time-series prediction RNN, Transformer for confirmation method recommendation, regression model for efficiency evaluation). Example inputs include “Past 5 times: code review, test execution, static analysis, code review, test execution” or “Project: API development”. The AI model outputs the optimal confirmation method candidates expected for the next confirmation (e.g., probability-labeled list), recommendation reasons (e.g., high-efficiency confirmation methods in the past, project similarity), and efficiency scores (e.g., average confirmation time, error detection rate). Example outputs include “Candidate: static analysis (0.72), test execution (0.18)” or “Reason: high efficiency with static analysis in the past 3 times”. Based on these outputs, the confirmation unit executes subsequent processing such as automatic display of candidate lists for confirmation methods, automatic switching of confirmation UI, and enabling of auto-completion functions from history. During training of history analysis algorithms, the confirmation unit applies reinforcement learning or supervised learning with confirmation completion rate and user satisfaction as objective functions, and continuously improves the personalization performance of the model. Unlike conventional static candidate presentation or simple history reference, the confirmation unit achieves dynamic recommendation and history analysis in a multidimensional feature space using AI, thereby achieving technical effects such as significant improvement in confirmation efficiency, reduction of confirmation errors, and optimization of user experience. Application fields include code review in software development, confirmation of diagnostic results in medical settings, quality inspection in manufacturing, and audits in financial systems, and can be applied to any business system where confirmation optimization based on history is effective.

The confirmation unit is capable of dynamically changing confirmation items according to the progress of the project at the time of confirmation. For example, in the initial stage of a project, the confirmation unit allows confirmation of only basic items. In the middle stage of a project, the confirmation unit allows confirmation of detailed items. In the final stage of a project, the confirmation unit can allow confirmation of items for final confirmation. Thus, by dynamically changing confirmation items according to the progress of the project, the confirmation unit can confirm appropriate items. Specifically, the confirmation unit obtains the progress status of each project (e.g., start date, milestone achievement rate, remaining task count, progress status, etc.) from project management systems or ticket management databases via API. The confirmation unit applies confirmation item control algorithms (e.g., rule-based branching, decision trees, progress cluster classifiers) based on progress data (e.g., numerical vectors such as progress rates 0.15, 0.55, 0.95). The confirmation unit inputs progress feature vectors and past confirmation history into AI models (e.g., LightGBM for progress state classification, Transformer for confirmation item recommendation). Example inputs include “Progress rate 0.10: only basic items,” “Progress rate 0.60: detailed items+constraint conditions,” or “Progress rate 0.95: final confirmation items.” The AI model outputs the optimal confirmation item list for the current progress status (e.g., labeled list of required items, recommended items, optional items), confirmation order, and confirmation UI layout proposals. Example outputs include “Initial: basic function confirmation,” “Middle: detailed function+constraint condition confirmation,” or “Final: pre-release final confirmation.” Based on these outputs, the confirmation unit executes subsequent processing such as dynamic generation of confirmation forms, display/hide control of items, and automatic adjustment of confirmation order. The confirmation unit continuously learns the correspondence between progress status and confirmation items, and strengthens personalization according to project characteristics and user behavior. Unlike conventional static confirmation item design, the confirmation unit achieves dynamic confirmation control according to project progress, thereby achieving technical effects such as prevention of confirmation omissions, improvement of confirmation efficiency, and homogenization of project quality. Application fields include release management in software development, progress inspection in construction projects, process inspection in manufacturing, and progress management in research and development, and can be applied to any field where confirmation optimization according to progress status is required.

The confirmation unit is capable of estimating a user's emotion and determining the priority of confirmation based on the estimated emotion. For example, when the user feels stressed, the confirmation unit allows confirmation of important items with priority. When the user is relaxed, the confirmation unit allows confirmation of detailed items. Additionally, when the user is in a hurry, the confirmation unit can allow confirmation of only the most important items. Thus, by determining the priority of confirmation according to the user's emotion, the confirmation unit can allow confirmation of important items with priority. Emotion estimation is realized, for example, by using an emotion estimation function with an emotion engine or a generation AI. The generation AI may be a text generation AI (e.g., LLM) or a multimodal generation AI, but is not limited to these examples. Specifically, the confirmation unit uses the user's emotion estimation result (e.g., category labels such as stress, relaxation, excitement, hurry, and an emotion intensity score from 0.0 to 1.0) received from the reception unit as input parameters. For emotion estimation, the confirmation unit obtains multimodal data via the reception unit, such as facial images (224×224 pixel RGB image tensor), audio waveforms (1D array sampled at 16 kHz), input text (up to 512 tokens), mouse operation logs (time-series vectors), and keystroke intervals (numerical series), and utilizes emotion categories and intensity scores estimated by a multimodal emotion estimation model (e.g., a fusion model of image CNN, audio RNN, and text Transformer). The confirmation unit assigns importance scores (e.g., weights based on project characteristics and past confirmation history) to confirmation item lists (e.g., function confirmation, security confirmation, performance confirmation, etc.), and applies priority determination algorithms (e.g., weighted sorting, threshold judgment) by combining them with emotion estimation results. As output, the confirmation unit generates a prioritized confirmation item list (e.g., only required items in stress state, all items in relaxed state, only the most important items in hurry state), and performs display control of the confirmation UI and automatic adjustment of confirmation order. The confirmation unit records emotion estimation history and confirmation behavior logs in a database, which can be used for future personalization and model retraining. Unlike conventional static confirmation order or uniform item presentation, the confirmation unit dynamically optimizes confirmation priority according to the user's real-time emotional state, thereby achieving technical effects such as prevention of omission of important items, improvement of confirmation efficiency, and reduction of user burden. Application fields include code review in software development, confirmation of diagnostic results in medical settings, and customer support inquiry handling, and can be applied to any field where priority control of confirmation items is effective.

The confirmation unit is capable of considering the user's geographic location information at the time of confirmation to preferentially confirm highly relevant confirmation items. For example, when the user is in a specific region, the confirmation unit allows confirmation of items related to that region with priority. When the user is in transit, the confirmation unit allows confirmation of items related to the destination with priority. Additionally, when the user is involved in a specific project, the confirmation unit can allow confirmation of items related to that project with priority. Thus, by considering the user's geographic location information, the confirmation unit can preferentially confirm highly relevant confirmation items. Specifically, the confirmation unit obtains geographic location information (e.g., latitude and longitude coordinates, region codes, country/city names) in real time from the user's device via GPS, Wi-Fi, IP address, etc. The confirmation unit matches the location information with a geographic condition database (e.g., region-specific regulations, local requirements, project site information) and calculates relevance scores (e.g., region match degree, destination prediction probability, project relevance). The confirmation unit inputs current location, movement history, and project attribute vectors into AI models (e.g., location information-based confirmation item recommendation classifier, neural network with geographic features as input). Example inputs include “Current location: Chiyoda-ku, Tokyo,” “Destination: Osaka City,” or “Project: Kansai site.” The AI model outputs a prioritized confirmation item list (e.g., region-specific security requirements, local regulations, site-specific operational rules), priority scores, and recommendation reasons. Example outputs include “Priority: API constraint for Kansai site (0.92),” “Reason: destination is Osaka City.” Based on these outputs, the confirmation unit executes subsequent processing such as automatic display of candidate lists for confirmation forms, application of region-specific templates, and automatic sorting of confirmation items. The confirmation unit continuously learns personalization algorithms that combine geographic location information and confirmation history, and provides the optimal confirmation experience for each user. Unlike conventional uniform confirmation item presentation, the confirmation unit dynamically prioritizes highly relevant items according to the user's current location and movement status, thereby achieving technical effects such as improved confirmation efficiency, prevention of omission of regional requirements, and homogenization of project quality. Application fields include global software development, financial and medical systems requiring local regulatory compliance, and site management in logistics and transportation, and can be applied to any field where geographic requirements are important.

The confirmation unit is capable of analyzing the user's social media activity at the time of confirmation to propose relevant confirmation items. For example, the confirmation unit proposes confirmation items related to projects mentioned by the user on social media. The confirmation unit can also propose confirmation items based on information shared by the user on social media. Additionally, the confirmation unit can propose confirmation items related to specific topics based on the user's social media activity. Thus, by analyzing the user's social media activity, the confirmation unit can propose relevant confirmation items. Specifically, the confirmation unit obtains the user's public social media post data (e.g., text posts, images, hashtags, post date and time, posts with location information) via API, and analyzes the post content using natural language processing engines and image analysis modules. For text posts, the confirmation unit performs preprocessing such as tokenization, named entity extraction, topic clustering, and sentiment analysis, and for image posts, applies image classification models and object detection models to vectorize the content. The confirmation unit integrates these features as multidimensional vectors (e.g., 512-dimensional text embedding, 2048-dimensional image feature vector, one-hot vector for hashtags), and inputs them into AI models (e.g., Transformer-based topic estimation model, neural network for confirmation item recommendation). Example inputs include “#ProjectX,” “API security enhancement,” or “Image: design drawing.” The AI model outputs highly relevant confirmation item candidates (e.g., API authentication enhancement confirmation, design review required, confirmation of additional specific functions), relevance scores (0.0 to 1.0), and recommendation reasons (e.g., posting frequency, topic match degree, relevance to image content). Example outputs include “API authentication enhancement confirmation (0.88): from #ProjectX post,” “Design review required (0.75): from image analysis result.” Based on these outputs, the confirmation unit executes subsequent processing such as automatic display of candidate lists for confirmation forms, automatic application of confirmation templates, and sorting of confirmation items. The confirmation unit continuously learns the correspondence between social media activity and confirmation items, and can incorporate algorithms to personalize item recommendations for each user. Unlike conventional static item input or simple history reference, the confirmation unit dynamically utilizes social media as an external information source to realize confirmation item proposals that reflect the user's interests and latest project trends in real time, thereby achieving technical effects such as improved confirmation efficiency, prevention of item omissions, and homogenization of project quality. Application fields include release management in software development, requirement confirmation for marketing initiatives, automatic generation of FAQs in customer support, and curriculum design in education, and can be applied to any field where the user's external activities affect business requirements.

The variation providing unit is capable of estimating a user's emotion and determining the priority of provided variations based on the estimated emotion. For example, when the user feels stressed, the variation providing unit provides important variations with priority. When the user is relaxed, the variation providing unit provides detailed variations. Additionally, when the user is in a hurry, the variation providing unit can provide only the most important variations. Thus, by determining the priority of variations according to the user's emotion, the variation providing unit can provide important variations with priority. Emotion estimation is realized, for example, by using an emotion estimation function with an emotion engine or a generation AI. The generation AI may be a text generation AI (e.g., LLM) or a multimodal generation AI, but is not limited to these examples. Specifically, for emotion estimation, the variation providing unit simultaneously obtains input data from multiple modalities, such as facial images (224×224 pixel RGB image tensor), audio waveforms (1D array sampled at 16 kHz), input text (natural language sentences up to 512 tokens), mouse operation logs (time-series vectors), and keystroke intervals (numerical series). The variation providing unit performs preprocessing such as normalization, noise removal, and feature extraction (e.g., facial expression feature vectors, audio spectrograms, BERT embeddings, operation speed statistics) on this input data, and inputs it into a multimodal emotion estimation model (e.g., a fusion model of image CNN, audio RNN, and text Transformer). The variation providing unit receives as output from the AI model the emotion category (e.g., labels such as stress, relaxation, excitement, hurry), emotion intensity score (continuous value from 0.0 to 1.0), and contribution of features that serve as the basis for estimation. Example outputs include “Stress: 0.82,” “Relaxation: 0.15,” “Audio features are the main factor.” Based on these output results, the variation providing unit assigns importance scores (e.g., weights based on project characteristics and past selection history) to the variation list (e.g., Algorithm A, Algorithm B, parameter sets X, Y, Z, etc.), and applies priority determination algorithms (e.g., weighted sorting, threshold judgment) by combining them with emotion estimation results. As output, the variation providing unit generates a prioritized variation list (e.g., only required variations in stress state, all variations in relaxed state, only the most important variations in hurry state), and performs display UI control and automatic adjustment of provision order. The variation providing unit records emotion estimation history and variation selection behavior logs in a database, which can be used for future personalization and model retraining. Unlike conventional static variation presentation or uniform provision order, the variation providing unit dynamically optimizes variation priority according to the user's real-time emotional state, thereby achieving technical effects such as prevention of omission of important variations, improved selection efficiency, and reduced user burden. Application fields include code auto-generation variation presentation in software development, design pattern selection support, assignment variation presentation in education, and diagnostic algorithm selection in medical settings, and can be applied to any field where the user's psychological state affects variation selection efficiency and quality.

The variation providing unit is capable of referring to past variation provision history at the time of providing variations to propose the optimal provision method. For example, the variation providing unit preferentially proposes variation provision methods that the user has frequently used in the past. The variation providing unit can also propose variation provision methods related to a specific project based on the user's past variation provision history. Additionally, the variation providing unit can analyze the user's past variation provision history to propose the most efficient variation provision method. Thus, by referring to past variation provision history, the variation providing unit can propose the optimal provision method. Specifically, the variation providing unit maintains a variation provision history database for each user (e.g., a structured table including variation ID, provision date and time, provision method, project ID, selection rate, provision completion rate, etc.). The variation providing unit applies algorithms such as time-series analysis (e.g., extraction of recent N provision trends), frequency analysis (e.g., aggregation of occurrence count for each variation), and clustering (e.g., grouping by project or function) to the history data. The variation providing unit inputs history vectors (e.g., sequence of variation IDs for the past 10 provisions, one-hot vector for provision methods, project features) into AI models (e.g., time-series prediction RNN, Transformer for provision method recommendation, regression model for efficiency evaluation). Example inputs include “Past 5 times: Algorithm A, Parameter set X, Algorithm B,” “Provision method: list display, grid display, list display,” etc. The AI model outputs the optimal variation provision method candidates expected for the next provision (e.g., probability-labeled list), recommendation reasons (e.g., high-efficiency provision methods in the past, project similarity), and efficiency scores (e.g., average selection time, selection rate). Example outputs include “Candidate: grid display (0.72), list display (0.18),” “Reason: high efficiency with grid display in the past 3 times.” Based on these outputs, the variation providing unit executes subsequent processing such as automatic display of candidate lists for provision methods, automatic switching of provision UI, and enabling of auto-completion functions from history. During training of history analysis algorithms, the variation providing unit applies reinforcement learning or supervised learning with provision completion rate and user satisfaction as objective functions, and continuously improves the personalization performance of the model. Unlike conventional static candidate presentation or simple history reference, the variation providing unit achieves dynamic recommendation and history analysis in a multidimensional feature space using AI, thereby achieving technical effects such as significant improvement in provision efficiency, reduction of selection errors, and optimization of user experience. Application fields include code variation presentation in software development, design pattern selection support, assignment variation presentation in education, and process selection in manufacturing, and can be applied to any business system where provision optimization based on history is effective.

The variation providing unit is capable of dynamically changing provision items according to the progress of the project at the time of providing variations. For example, in the initial stage of a project, the variation providing unit provides only basic variations. In the middle stage of a project, the variation providing unit provides detailed variations. In the final stage of a project, the variation providing unit can provide variations for final confirmation. Thus, by dynamically changing provision items according to the progress of the project, the variation providing unit can provide appropriate variations. Specifically, the variation providing unit obtains the progress status of each project (e.g., start date, milestone achievement rate, remaining task count, progress status, etc.) from project management systems or ticket management databases via API. The variation providing unit applies provision item control algorithms (e.g., rule-based branching, decision trees, progress cluster classifiers) based on progress data (e.g., numerical vectors such as progress rates 0.15, 0.55, 0.95). The variation providing unit inputs progress feature vectors and past variation provision history into AI models (e.g., LightGBM for progress state classification, Transformer for provision item recommendation). Example inputs include “Progress rate 0.10: only basic variations,” “Progress rate 0.60: detailed variations+constraint conditions,” or “Progress rate 0.95: variations for final confirmation.” The AI model outputs the optimal provision item list for the current progress status (e.g., labeled list of required variations, recommended variations, optional variations), provision order, and provision UI layout proposals. Example outputs include “Initial: Algorithm A,” “Middle: Parameter set X, Algorithm B,” or “Final: variations for final confirmation.” Based on these outputs, the variation providing unit executes subsequent processing such as dynamic generation of provision forms, display/hide control of items, and automatic adjustment of provision order. The variation providing unit continuously learns the correspondence between progress status and provision items, and strengthens personalization according to project characteristics and user behavior. Unlike conventional static provision item design, the variation providing unit achieves dynamic provision control according to project progress, thereby achieving technical effects such as prevention of provision omissions, improvement of provision efficiency, and homogenization of project quality. Application fields include code variation presentation in software development, design pattern selection support, process variation presentation in manufacturing, and progress management in research and development, and can be applied to any field where provision optimization according to progress status is required.

The variation providing unit is capable of estimating a user's emotion and adjusting the display method of provided variations based on the estimated emotion. For example, when the user feels stressed, the variation providing unit provides a simple display method and minimizes display procedures. When the user is relaxed, the variation providing unit provides detailed display options and proposes customizable display methods. Additionally, when the user is in a hurry, the variation providing unit can provide methods for rapid display. By adjusting the display method of variations according to the user's emotion, the variation providing unit can provide an appropriate display method for the user. Emotion estimation is realized, for example, by using an emotion estimation function with an emotion engine or a generation AI. The generation AI may be a text generation AI (e.g., LLM) or a multimodal generation AI, but is not limited to these examples. Specifically, for emotion estimation, the variation providing unit simultaneously obtains input data from multiple modalities, such as facial images (224×224 pixel RGB image tensor), audio waveforms (1D array sampled at 16 kHz), input text (natural language sentences up to 512 tokens), mouse operation logs (time-series vectors), and keystroke intervals (numerical series). The variation providing unit performs preprocessing such as normalization, noise removal, and feature extraction (e.g., facial expression feature vectors, audio spectrograms, BERT embeddings, operation speed statistics) on this input data, and inputs it into a multimodal emotion estimation model (e.g., a fusion model of image CNN, audio RNN, and text Transformer). The variation providing unit receives as output from the AI model the emotion category (e.g., labels such as stress, relaxation, excitement, hurry), emotion intensity score (continuous value from 0.0 to 1.0), and contribution of features that serve as the basis for estimation. Example outputs include “Stress: 0.82,” “Relaxation: 0.15,” “Audio features are the main factor.” Based on these output results, the variation providing unit automatically executes subsequent processing such as switching display UI layouts (e.g., list display, grid display, display/hide of detailed options), shortening display procedures (e.g., displaying only required variations), and enabling customization functions (e.g., sorting, filtering). During training of the emotion estimation model, the variation providing unit performs cross-entropy loss and weight optimization of multimodal feature fusion layers, and during inference, combines threshold judgment and heuristic rules to realize dynamic UI control. The variation providing unit records emotion estimation history and display behavior logs in a database, which can be used for future personalization and model retraining. Unlike conventional static UI design, the variation providing unit dynamically optimizes display methods according to the user's real-time emotional state, thereby achieving technical effects such as significant reduction of user burden, reduction of selection errors, and improvement of selection completion rate. Application fields include code variation presentation UI in software development, design pattern selection support, assignment variation presentation in education, and diagnostic algorithm selection in medical settings, and can be applied to any field where the user's psychological state affects display efficiency and quality.

The variation providing unit is capable of considering the user's geographic location information at the time of providing variations to preferentially provide highly relevant variations. For example, when the user is in a specific region, the variation providing unit provides variations related to that region with priority. When the user is in transit, the variation providing unit provides variations related to the destination with priority. Additionally, when the user is involved in a specific project, the variation providing unit can provide variations related to that project with priority. Thus, by considering the user's geographic location information, the variation providing unit can preferentially provide highly relevant variations. Specifically, the variation providing unit obtains geographic location information (e.g., latitude and longitude coordinates, region codes, country/city names) in real time from the user's device via GPS, Wi-Fi, IP address, etc. The variation providing unit matches the location information with a geographic condition database (e.g., region-specific regulations, local requirements, project site information) and calculates relevance scores (e.g., region match degree, destination prediction probability, project relevance). The variation providing unit inputs current location, movement history, and project attribute vectors into AI models (e.g., location information-based variation recommendation classifier, neural network with geographic features as input). Example inputs include “Current location: Chiyoda-ku, Tokyo,” “Destination: Osaka City,” or “Project: Kansai site.” The AI model outputs a prioritized variation list (e.g., region-specific algorithms, variations for local regulatory compliance, site-specific operational rules), priority scores, and recommendation reasons. Example outputs include “Priority: API constraint variation for Kansai site (0.92),” “Reason: destination is Osaka City.” Based on these outputs, the variation providing unit executes subsequent processing such as automatic display of candidate lists for provision forms, application of region-specific templates, and automatic sorting of provision items. The variation providing unit continuously learns personalization algorithms that combine geographic location information and provision history, and provides the optimal provision experience for each user. Unlike conventional uniform provision item presentation, the variation providing unit dynamically prioritizes highly relevant variations according to the user's current location and movement status, thereby achieving technical effects such as improved provision efficiency, prevention of omission of regional requirements, and homogenization of project quality. Application fields include global software development, financial and medical systems requiring local regulatory compliance, and site management in logistics and transportation, and can be applied to any field where geographic requirements are important.

The variation providing unit is capable of analyzing the user's social media activity at the time of providing variations to propose relevant variations. For example, the variation providing unit proposes variations related to projects mentioned by the user on social media. The variation providing unit can also propose variations based on information shared by the user on social media. Additionally, the variation providing unit can propose variations related to specific topics based on the user's social media activity. Thus, by analyzing the user's social media activity, the variation providing unit can propose relevant variations. Specifically, the variation providing unit obtains the user's public social media post data (e.g., text posts, images, hashtags, post date and time, posts with location information) via API, and analyzes the post content using natural language processing engines and image analysis modules. For text posts, the variation providing unit performs preprocessing such as tokenization, named entity extraction, topic clustering, and sentiment analysis, and for image posts, applies image classification models and object detection models to vectorize the content. The variation providing unit integrates these features as multidimensional vectors (e.g., 512-dimensional text embedding, 2048-dimensional image feature vector, one-hot vector for hashtags), and inputs them into AI models (e.g., Transformer-based topic estimation model, neural network for variation recommendation). Example inputs include “#ProjectX,” “API security enhancement,” or “Image: design drawing.” The AI model outputs highly relevant variation candidates (e.g., API authentication enhancement variation, design review required variation, specific function addition variation), relevance scores (0.0 to 1.0), and recommendation reasons (e.g., posting frequency, topic match degree, relevance to image content). Example outputs include “API authentication enhancement variation (0.88): from #ProjectX post,” “Design review required variation (0.75): from image analysis result.” Based on these outputs, the variation providing unit executes subsequent processing such as automatic display of candidate lists for provision forms, automatic application of variation templates, and sorting of provision items. The variation providing unit continuously learns the correspondence between social media activity and variations, and can incorporate algorithms to personalize variation recommendations for each user. Unlike conventional static variation input or simple history reference, the variation providing unit dynamically utilizes social media as an external information source to realize variation proposals that reflect the user's interests and latest project trends in real time, thereby achieving technical effects such as improved provision efficiency, prevention of variation omissions, and homogenization of project quality. Application fields include variation presentation in software development, requirement extraction for marketing initiatives, automatic generation of FAQs in customer support, and assignment variation design in education, and can be applied to any field where the user's external activities affect business requirements.

The system according to the embodiment is not limited to the examples described above and can be variously modified as follows, for example. Specifically, the system allows diverse variations in all technical elements, such as the internal algorithms and data flows of each component (reception unit, generation unit, confirmation unit, variation providing unit), AI model architectures, input/output interfaces, learning methods, personalization techniques, database structures, UI design, communication protocols, and security measures. For example, in the reception unit, the system can combine user input interfaces such as speech recognition, handwriting recognition, gesture input, and multimodal input (image+audio+text). In the generation unit, the system can select and combine the optimal AI models according to the application and data characteristics, including not only Transformer-based large language models but also CNNs, RNNs, graph neural networks, and reinforcement learning agents. In the confirmation unit, the system can integrally apply multiple confirmation algorithms, such as static analysis, dynamic analysis, formal methods, property-based testing, coverage analysis, and AI-based automatic bug detection. In the variation providing unit, the system can score generated source code variations using multidimensional evaluation metrics such as performance, security, readability, extensibility, resource consumption, and execution environment compatibility, and automatically select and present the optimal variations according to user and project characteristics. The system can flexibly adopt learning methods for AI models, such as supervised learning, self-supervised learning, transfer learning, meta-learning, federated learning, and online learning. The system can select database structures according to the application, such as relational databases, NoSQL, graph DBs, and time-series DBs. To enhance personalization for each user, the system can integrally analyze user behavior logs, emotion estimation history, input/confirmation/variation selection history, and optimize UI and algorithms in real time. For security measures, the system can implement a combination of communication encryption, authentication/authorization, tampering detection, access control, and AI-based anomaly detection. The system can adapt to various execution platforms, including cloud environments, on-premises environments, edge devices, and distributed computing environments. By allowing these diverse technical variations, the system achieves remarkable technical effects such as flexibility, scalability, adaptability, operational efficiency, security, and improved user experience compared to conventional single-configuration and static designs. Application fields include software development support, medical information systems, process management in manufacturing, learning support in education, automation in financial systems, IoT device management, and robotics control, and can be applied to any field that requires handling complex and diverse requirements.

The reception unit is capable of analyzing the user's past input history to propose the optimal input method. For example, the reception unit preferentially proposes input methods that the user has frequently used in the past. Additionally, the reception unit can predict and propose acceptance conditions related to a specific project based on the user's past input history. Thus, by analyzing past input history, the reception unit can provide the optimal input method for the user. Specifically, the reception unit maintains an input history database for each user (e.g., a structured table including input date and time, input method ID, project ID, input content, input completion rate, input time required, etc.). The reception unit applies algorithms such as time-series analysis (e.g., extraction of recent N input trends), frequency analysis (e.g., aggregation of usage count for each input method), and clustering (e.g., grouping by project or function) to the history data. The reception unit inputs history vectors (e.g., sequence of input method IDs for the past 10 inputs, project features, input time vectors) into AI models (e.g., time-series prediction RNN, Transformer for input method recommendation, regression model for efficiency evaluation). Example inputs include “Past 5 times: speech, text, speech, speech, text,” “Project: API development,” etc. The AI model outputs the optimal input method candidates expected for the next input (e.g., probability-labeled list), recommendation reasons (e.g., high-efficiency input methods in the past, project similarity), and efficiency scores (e.g., average input time, input completion rate). Example outputs include “Candidate: speech input (0.72), text input (0.18),” “Reason: high efficiency with speech input in the past 3 times.” Based on these outputs, the reception unit executes subsequent processing such as automatic display of candidate lists for input methods, automatic switching of input UI, and enabling of auto-completion functions from history. During training of history analysis algorithms, the reception unit applies reinforcement learning or supervised learning with input completion rate and user satisfaction as objective functions, and continuously improves the personalization performance of the model. Unlike conventional static candidate presentation or simple history reference, the reception unit achieves dynamic recommendation and history analysis in a multidimensional feature space using AI, thereby achieving technical effects such as significant improvement in input efficiency, reduction of input errors, and optimization of user experience. Application fields include requirements management in software development, FAQ input in customer support, medical record input in medical settings, and quality management systems in manufacturing, and can be applied to any business system where input optimization based on history is effective.

The generation unit is capable of evaluating the quality of the generated source code and automatically making corrections as necessary. For example, the generation unit checks the quality of the generated source code using static analysis tools and automatically corrects bugs and security issues. Additionally, the generation unit can evaluate the performance of the generated source code and optimize it as needed. As a result, the generation unit can improve the quality of the generated source code. Specifically, the generation unit receives fragments of source code immediately after generation (e.g., token sequences or AST structures at the function, file, or project level) as input and applies static analysis engines (e.g., syntax error detection, type checking, security vulnerability scanners, coding convention checkers) and dynamic analysis engines (e.g., automatic generation and execution of unit tests, profilers, memory leak detectors). The generation unit inputs code feature vectors (e.g., AST node distribution, control flow graphs, function call graphs, code metrics) into AI models (e.g., graph neural networks for bug detection, security vulnerability classifiers, regression models for performance prediction). Examples of input include “def authenticate_user( . . . ): . . . ” and “Code metrics: complexity 12, lines 45”. The AI model outputs quality evaluation scores (e.g., bug risk 0.12, security vulnerability 0.08, performance score 0.91), lists of recommended correction points (e.g., line numbers, function names, reasons for correction), and automatic correction proposals (e.g., vulnerability patches, optimized code fragments). Examples of output include “Correction proposal: if obj is not None: . . . #Added null check” and “Performance optimization: async def fetch_data( . . . ): . . . #Asynchronous processing”. Based on these outputs, the generation unit performs subsequent processing such as automatic code correction, regeneration, presentation of correction proposals, and recording of correction history. During training of quality evaluation and automatic correction algorithms, the generation unit uses bug fix histories and performance improvement cases as training data and optimizes weights by combining quality matching loss and correction fitness loss as loss functions. Unlike conventional manual reviews or simple static analysis, the generation unit achieves quality evaluation and automatic correction in a multidimensional feature space using AI, thereby providing technical effects such as reduction of bug introduction rate, minimization of security risks, automation of performance optimization, and significant improvement in development efficiency. Application fields include security fixes for financial systems, addition of critical functions to medical systems, performance optimization of web services, and bug fixes for embedded systems, and can be applied to any field where quality and risk are important.

The confirmation unit is capable of estimating the user's emotion and adjusting the confirmation method based on the estimated emotion. For example, if the user is feeling stressed, the confirmation unit provides a simple confirmation method and minimizes the confirmation procedure. If the user is relaxed, the confirmation unit provides detailed confirmation options and proposes customizable confirmation methods. Additionally, if the user is in a hurry, the confirmation unit can provide methods for rapid confirmation. Thus, by adjusting the confirmation method according to the user's emotion, the confirmation unit can provide an appropriate confirmation method for the user. Specifically, the confirmation unit uses the user's emotion estimation results received from the reception unit (e.g., category labels such as stress, relaxation, excitement, impatience, and emotion intensity scores from 0.0 to 1.0) as input parameters. For emotion estimation, the confirmation unit obtains multimodal data via the reception unit, such as facial images (224×224 pixel RGB image tensors), audio waveforms (1D arrays sampled at 16 kHz), input text (up to 512 tokens), mouse operation logs (time series vectors), and keystroke intervals (numerical series), and utilizes emotion categories and intensity scores estimated by a multimodal emotion estimation model (e.g., a fusion model of image CNN, audio RNN, and text Transformer). The confirmation unit incorporates this emotion information as input parameters for confirmation procedure control algorithms (e.g., rule-based branching, decision trees, emotion state classifiers) and UI control modules. For example, in a stress state, the confirmation unit displays only required items and automatically generates a simple UI with minimal confirmation steps. In a relaxed state, the confirmation unit enables detailed confirmation options (e.g., additional checklists, detailed log display, customizable confirmation flows) and allows the user to freely select confirmation procedures. In a hurried state, the confirmation unit prioritizes interfaces that allow rapid operations, such as voice input or one-click confirmation. According to the emotion estimation results, the confirmation unit executes subsequent processing such as display/hide control of confirmation items, automatic adjustment of confirmation order, and activation of auxiliary functions (e.g., automatic error correction proposals, history reference). The confirmation unit records emotion estimation history and confirmation behavior logs in a database, which can be used for future personalization and model retraining. Unlike conventional static confirmation procedure design, the confirmation unit dynamically optimizes the confirmation method according to the user's real-time emotional state, thereby providing technical effects such as significant reduction of user burden, reduction of confirmation errors, and improvement of confirmation completion rate. Application fields include code review systems in software development, confirmation of diagnostic results in medical settings, audit checklists in financial systems, and assignment submission confirmation in education, and can be applied to any field where the user's psychological state affects confirmation efficiency and quality.

The variation providing unit is capable of evaluating variations of generated source code and automatically selecting the optimal variation. For example, the variation providing unit compares variations of generated source code and selects the variation with the highest performance. Additionally, the variation providing unit can evaluate variations of generated source code and select the variation with the highest security. Thus, by evaluating variations of generated source code, the variation providing unit can provide the optimal variation. Specifically, the variation providing unit receives multiple source code variations from the generation unit (e.g., code fragments with different algorithms, parameter settings, or optimization levels) as input. For each variation, the variation providing unit performs multidimensional evaluation using static analysis (e.g., complexity, line count, dependencies, security vulnerability scores), dynamic analysis (e.g., execution speed, memory consumption, test coverage, error rate), and AI models (e.g., performance prediction regression models, security vulnerability classifiers, readability evaluation neural networks). Examples of input include “Variation A: Algorithm X, Parameter Set Y” and “Variation B: Algorithm Z, Parameter Set W”. As output, the variation providing unit generates evaluation scores for each variation (e.g., performance 0.91, security 0.98, readability 0.85) and recommendation reasons (e.g., fastest execution speed, zero vulnerabilities, abundant comments), and automatically selects the optimal variation. Examples of output include “Selected: Variation B (best performance, highest security)”. During training of evaluation and selection algorithms, the variation providing unit uses operational data and user selection history as training data and optimizes weights by combining selection matching loss and multi-objective optimization loss as loss functions. Unlike conventional manual variation selection or simple performance comparison, the variation providing unit achieves automatic evaluation and optimal selection in a multidimensional feature space using AI, thereby providing technical effects such as reduction of selection errors, optimal balance of quality, performance, and security, and improvement of development efficiency. Application fields include automatic code generation variation presentation in software development, design pattern selection support, diagnostic algorithm selection in medical settings, and process optimization in manufacturing, and can be applied to any field where variation evaluation and selection directly affect quality and efficiency.

The reception unit is capable of estimating the user's emotion and adjusting the method of inputting acceptance conditions based on the estimated emotion. For example, if the user is feeling stressed, the reception unit provides a simple interface and minimizes the input procedure. If the user is relaxed, the reception unit provides detailed input options and proposes customizable input methods. Additionally, if the user is in a hurry, the reception unit prioritizes voice input to enable rapid entry of acceptance conditions. Thus, by adjusting the method of inputting acceptance conditions according to the user's emotion, the reception unit reduces the user's burden. Specifically, for emotion estimation, the reception unit simultaneously acquires input data from multiple modalities, such as facial images (224×224 pixel RGB image tensors), audio waveforms (1D arrays sampled at 16 kHz), input text (natural language sentences up to 512 tokens), mouse operation logs (time series vectors), and keystroke intervals (numerical series). The reception unit performs preprocessing on these input data, such as normalization, noise removal, and feature extraction (e.g., facial expression feature vectors, audio spectrograms, BERT embeddings, operation speed statistics), and inputs them into a multimodal emotion estimation model (e.g., a fusion model of image CNN, audio RNN, and text Transformer). The AI model outputs emotion categories (e.g., stress, relaxation, excitement, impatience), emotion intensity scores (continuous values from 0.0 to 1.0), and contribution rates of features used for estimation. Examples of output include “Stress: 0.82”, “Relaxation: 0.15”, “Audio features are the main factor”. Based on these output results, the reception unit automatically executes subsequent processing such as switching UI layouts (e.g., simplifying input items, emphasizing voice input buttons, showing/hiding detailed options), enabling input assistance functions (e.g., autocomplete, history candidate suggestions), and shortening input procedures (e.g., displaying only required items). During training of the emotion estimation model, the reception unit optimizes weights for cross-entropy loss and multimodal feature fusion layers, and during inference, dynamically controls the UI by combining threshold judgment and heuristic rules. The reception unit records emotion estimation history and input behavior logs in a database, which can be used for future personalization and model retraining. Unlike conventional static UI design, the reception unit dynamically optimizes the input method according to the user's real-time emotional state, thereby providing technical effects such as significant reduction of user burden, reduction of input errors, and improvement of input completion rate. Application fields include requirements management in software development, inquiry reception in customer support, electronic medical record input in medical settings, and learning management systems in education, and can be applied to any field where the user's psychological state affects input efficiency and quality.

When providing variations of generated source code, the generation unit is capable of estimating the user's emotion and adjusting the display method of variations based on the estimated emotion. For example, if the user is feeling stressed, the generation unit provides a simple display method and minimizes the display procedure. If the user is relaxed, the generation unit provides detailed display options and proposes customizable display methods. Additionally, if the user is in a hurry, the generation unit can provide methods for rapid display. Thus, by adjusting the display method of variations according to the user's emotion, the generation unit can provide an appropriate display method for the user. Specifically, for emotion estimation, the generation unit simultaneously acquires input data from multiple modalities, such as facial images (224×224 pixel RGB image tensors), audio waveforms (1D arrays sampled at 16 kHz), input text (natural language sentences up to 512 tokens), mouse operation logs (time series vectors), and keystroke intervals (numerical series). The generation unit performs preprocessing on these input data, such as normalization, noise removal, and feature extraction (e.g., facial expression feature vectors, audio spectrograms, BERT embeddings, operation speed statistics), and inputs them into a multimodal emotion estimation model (e.g., a fusion model of image CNN, audio RNN, and text Transformer). The AI model outputs emotion categories (e.g., stress, relaxation, excitement, impatience), emotion intensity scores (continuous values from 0.0 to 1.0), and contribution rates of features used for estimation. Examples of output include “Stress: 0.82”, “Relaxation: 0.15”, “Audio features are the main factor”. Based on these output results, the generation unit automatically executes subsequent processing such as switching display UI layouts (e.g., list display, grid display, showing/hiding detailed options), shortening display procedures (e.g., displaying only required variations), and enabling customization functions (e.g., sorting, filtering). During training of the emotion estimation model, the generation unit optimizes weights for cross-entropy loss and multimodal feature fusion layers, and during inference, dynamically controls the UI by combining threshold judgment and heuristic rules. The generation unit records emotion estimation history and display behavior logs in a database, which can be used for future personalization and model retraining. Unlike conventional static UI design, the generation unit dynamically optimizes the display method according to the user's real-time emotional state, thereby providing technical effects such as significant reduction of user burden, reduction of selection errors, and improvement of selection completion rate. Application fields include code variation presentation UI in software development, design pattern selection support, assignment variation presentation in education, and diagnostic algorithm selection in medical settings, and can be applied to any field where the user's psychological state affects display efficiency and quality.

The reception unit is capable of prioritizing the input of highly relevant acceptance conditions by considering the user's geographic location information. For example, if the user is in a specific region, the reception unit prioritizes the input of acceptance conditions related to that region. If the user is in transit, the reception unit prioritizes the input of acceptance conditions related to the destination. Additionally, if the user is involved in a specific project, the reception unit can prioritize the input of acceptance conditions related to that project. Thus, by considering the user's geographic location information, the reception unit can prioritize the input of highly relevant acceptance conditions. Specifically, the reception unit acquires geographic location information (e.g., latitude and longitude coordinates, region codes, country/city names) in real time from the user's device via GPS, Wi-Fi, IP address, etc. Based on the location information, the reception unit cross-references a geographic condition database (e.g., region-specific regulations, local requirements, project site information) and calculates relevance scores (e.g., region match degree, destination prediction probability, project relevance). The reception unit inputs current location, movement history, and project attribute vectors into AI models (e.g., classifiers for recommending acceptance conditions based on location information, neural networks using geographic feature vectors). Examples of input include “Current location: Chiyoda-ku, Tokyo”, “Destination: Osaka City”, “Project: Kansai site”. The AI model outputs a list of acceptance conditions to be prioritized (e.g., region-specific security requirements, local legal regulations, site-specific operational rules), priority scores, and recommendation reasons. Examples of output include “Priority: API restrictions for Kansai site (0.92)”, “Reason: Destination is Osaka City”. Based on these outputs, the reception unit executes subsequent processing such as automatic display of candidate lists in input forms, application of region-specific templates, and automatic rearrangement of input items. The reception unit continuously learns a personalization algorithm that combines geographic location information and input history to provide the optimal input experience for each user. Unlike conventional uniform presentation of input items, the reception unit dynamically prioritizes the display of highly relevant acceptance conditions according to the user's current location and movement status, thereby providing technical effects such as improved input efficiency, prevention of omissions of regional requirements, and homogenization of project quality. Application fields include global software development, financial and medical systems requiring compliance with local regulations, and site management in logistics and transportation, and can be applied to any field where geographic requirements are important.

The generation unit is capable of evaluating the quality of the generated source code and automatically making corrections as necessary. For example, the generation unit checks the quality of the generated source code using static analysis tools and automatically corrects bugs and security issues. Additionally, the generation unit can evaluate the performance of the generated source code and optimize it as needed. As a result, the generation unit can improve the quality of the generated source code. Specifically, the generation unit receives fragments of source code immediately after generation (e.g., token sequences or AST structures at the function, file, or project level) as input and applies static analysis engines (e.g., syntax error detection, type checking, security vulnerability scanners, coding convention checkers) and dynamic analysis engines (e.g., automatic generation and execution of unit tests, profilers, memory leak detectors). The generation unit inputs code feature vectors (e.g., AST node distribution, control flow graphs, function call graphs, code metrics) into AI models (e.g., graph neural networks for bug detection, security vulnerability classifiers, regression models for performance prediction). Examples of input include “def authenticate_user( . . . ): . . . ” and “Code metrics: complexity 12, lines 45”. The AI model outputs quality evaluation scores (e.g., bug risk 0.12, security vulnerability 0.08, performance score 0.91), lists of recommended correction points (e.g., line numbers, function names, reasons for correction), and automatic correction proposals (e.g., vulnerability patches, optimized code fragments). Examples of output include “Correction proposal: if obj is not None: . . . #Added null check” and “Performance optimization: async def fetch_data( . . . ): . . . #Asynchronous processing”. Based on these outputs, the generation unit performs subsequent processing such as automatic code correction, regeneration, presentation of correction proposals, and recording of correction history. During training of quality evaluation and automatic correction algorithms, the generation unit uses bug fix histories and performance improvement cases as training data and optimizes weights by combining quality matching loss and correction fitness loss as loss functions. Unlike conventional manual reviews or simple static analysis, the generation unit achieves quality evaluation and automatic correction in a multidimensional feature space using AI, thereby providing technical effects such as reduction of bug introduction rate, minimization of security risks, automation of performance optimization, and significant improvement in development efficiency. Application fields include security fixes for financial systems, addition of critical functions to medical systems, performance optimization of web services, and bug fixes for embedded systems, and can be applied to any field where quality and risk are important.

The confirmation unit is capable of estimating the user's emotion and determining the priority of confirmation based on the estimated emotion. For example, if the user is feeling stressed, the confirmation unit prioritizes confirmation of important items. If the user is relaxed, the confirmation unit confirms detailed items. Additionally, if the user is in a hurry, the confirmation unit can confirm only the most important items. Thus, by determining the priority of confirmation according to the user's emotion, the confirmation unit can prioritize confirmation of important items. Specifically, the confirmation unit uses the user's emotion estimation results received from the reception unit (e.g., category labels such as stress, relaxation, excitement, impatience, and emotion intensity scores from 0.0 to 1.0) as input parameters. For emotion estimation, the confirmation unit obtains multimodal data via the reception unit, such as facial images (224×224 pixel RGB image tensors), audio waveforms (1D arrays sampled at 16 kHz), input text (up to 512 tokens), mouse operation logs (time series vectors), and keystroke intervals (numerical series), and utilizes emotion categories and intensity scores estimated by a multimodal emotion estimation model (e.g., a fusion model of image CNN, audio RNN, and text Transformer). For the confirmation item list (e.g., function confirmation, security confirmation, performance confirmation), the confirmation unit assigns importance scores (e.g., weights based on project characteristics and past confirmation history) and applies a priority determination algorithm (e.g., weighted sorting, threshold judgment) in combination with emotion estimation results. As output, the confirmation unit generates a prioritized confirmation item list (e.g., only required items during stress, all items during relaxation, only the most important items when in a hurry) and controls the display of the confirmation UI and automatically adjusts the confirmation order. The confirmation unit records emotion estimation history and confirmation behavior logs in a database, which can be used for future personalization and model retraining. Unlike conventional static confirmation order or uniform item presentation, the confirmation unit dynamically optimizes confirmation priorities according to the user's real-time emotional state, thereby providing technical effects such as prevention of omission of important items, improvement of confirmation efficiency, and reduction of user burden. Application fields include code review in software development, confirmation of diagnostic results in medical settings, and inquiry response in customer support, and can be applied to any field where control of confirmation item priorities is effective.

The variation providing unit is capable of analyzing the user's social media activity and proposing relevant variations. For example, the variation providing unit proposes variations related to projects mentioned by the user on social media. Additionally, the variation providing unit proposes relevant variations based on information shared by the user on social media. The variation providing unit can also propose variations related to specific topics based on the user's social media activity. Thus, by analyzing the user's social media activity, the variation providing unit can propose relevant variations. Specifically, the variation providing unit obtains the user's public social media post data (e.g., text posts, images, hashtags, post timestamps, location-tagged posts) via API and analyzes the content using natural language processing engines and image analysis modules. For text posts, the variation providing unit performs preprocessing such as tokenization, named entity extraction, topic clustering, and sentiment analysis, and for image posts, applies image classification models and object detection models to convert content into feature vectors. The variation providing unit integrates these features into multidimensional vectors (e.g., 512-dimensional text post embeddings, 2048-dimensional image feature vectors, hashtag one-hot vectors) and inputs them into AI models (e.g., Transformer-based topic estimation models, neural networks for variation recommendation). Examples of input include “#ProjectX”, “API security enhancement”, “Image: design drawing”. The AI model outputs highly relevant variation candidates (e.g., API authentication enhancement variation, design review required variation, specific function addition variation), relevance scores (0.0-1.0), and recommendation reasons (e.g., posting frequency, topic match degree, relevance to image content). Examples of output include “API authentication enhancement variation (0.88): from #ProjectX post” and “Design review required variation (0.75): from image analysis result”. Based on these outputs, the variation providing unit executes subsequent processing such as automatic display of candidate lists in the provision form, automatic application of variation templates, and rearrangement of provision items. The variation providing unit continuously learns the correspondence between social media activity and variations and can incorporate algorithms to personalize optimal variation recommendations for each user. Unlike conventional static variation input or simple history reference, the variation providing unit dynamically utilizes social media as an external information source to reflect the user's interests and latest project trends in real time in variation proposals, thereby providing technical effects such as improved provision efficiency, prevention of variation omissions, and homogenization of project quality. Application fields include variation presentation in software development, requirement extraction for marketing initiatives, automatic generation of FAQs in customer support, and assignment variation design in education, and can be applied to any field where the user's external activities affect business requirements.

Below, the processing flow of Example of the Embodiment is briefly described. Specifically, the present system operates in cooperation among each module: the reception unit, generation unit, confirmation unit, and variation providing unit. The reception unit receives acceptance conditions and target source code from the user via various input interfaces (e.g., text, voice, image, multimodal input), normalizes and extracts features from the input data, and integrates context information such as input history, geographic location information, and emotion estimation results. The reception unit inputs data vectors and history vectors into AI models (e.g., Transformer for input method recommendation, multimodal model for emotion estimation) and dynamically determines the optimal input method and input items. The generation unit inputs multidimensional tensors such as acceptance condition text (up to 4096 tokens) received from the reception unit, AST representations of target source code (up to 10,000 tokens), emotion categories and intensity scores, geographic features, and project progress into a large language model (e.g., Transformer-based encoder-decoder neural network) and generates source code fragments according to the modification content. During generation, the generation unit uses control tokens for emotion, importance, submission timing, relevance, and category to dynamically optimize code expression method, length, level of detail, generation order, and algorithm selection. After generation, the generation unit performs static analysis, dynamic analysis, AI-based quality evaluation, automatic correction, and performance optimization on the source code, and attaches quality scores and correction proposals. The confirmation unit, based on the source code fragments and quality evaluation information received from the generation unit, dynamically controls confirmation items, confirmation methods, priorities, and display UI by considering various contexts such as emotion estimation results, confirmation history, project progress, geographic location information, and social media activity. The confirmation unit inputs history vectors and emotion scores into AI models (e.g., Transformer for confirmation method recommendation, regression model for efficiency evaluation) and automatically generates the optimal confirmation flow. The variation providing unit scores multiple source code variations received from the generation unit using multidimensional evaluation metrics such as performance, security, readability, regional requirement compliance, and project characteristics, and automatically selects and presents the optimal variation by considering the user's emotion, history, geographic location, and social media activity. The variation providing unit dynamically optimizes display UI, provision order, and customization functions according to emotion estimation results and history. Through this series of processing flows, the present system, unlike conventional static and uniform business flows, achieves dynamic optimization and personalization in a multidimensional feature space using AI, and provides technical effects such as efficiency improvement, quality enhancement, and optimization of user experience in all processes of input, generation, confirmation, and variation selection. Application fields include software development support, medical information systems, process management in manufacturing, learning support in education, and automation of financial systems, and can be applied to any field that requires handling complex and diverse requirements.

Step 1: The reception unit inputs acceptance conditions. Acceptance conditions may include, for example, functional requirements, non-functional requirements, and constraint conditions, but are not limited to these examples. The reception unit inputs source code of the target system. The source code of the target system may include, for example, specific modules or the entire code base, but is not limited to these examples. Step 2: The generation unit generates source code for modification using AI. The generation unit generates source code for modification using technologies such as machine learning, deep learning, and natural language processing. Step 3: The confirmation unit allows the developer to confirm the generated source code and make corrections as necessary. The confirmation unit confirms the generated source code using methods such as code review, test execution, and static analysis. Step 4: The variation providing unit provides multiple generated source code variations. The variation providing unit provides variations such as different algorithms and different parameter settings. Specifically, in Step 1, the reception unit receives various input data from the user, including acceptance condition text (up to 4096 tokens), AST representation of the target source code (up to 10,000 tokens), project ID, input method (e.g., text, voice, image), geographic location information, and emotion estimation results. The reception unit normalizes and extracts features from the input data, cross-references with history databases and geographic condition databases, and determines the optimal input method and input items using AI models (e.g., Transformer for input method recommendation, multimodal model for emotion estimation). In Step 2, the generation unit inputs multidimensional tensors (acceptance conditions, source code AST, emotion categories and intensity scores, geographic features, project progress, etc.) received from the reception unit into a large language model (e.g., Transformer-based encoder-decoder neural network) and generates source code fragments according to the modification content. During generation, the generation unit uses control tokens for emotion, importance, submission timing, relevance, and category to dynamically optimize code expression method, length, level of detail, generation order, and algorithm selection. In Step 3, the confirmation unit, based on the source code fragments and quality evaluation information received from the generation unit, dynamically controls confirmation items, confirmation methods, priorities, and display UI by considering various contexts such as emotion estimation results, confirmation history, project progress, geographic location information, and social media activity. The confirmation unit inputs history vectors and emotion scores into AI models (e.g., Transformer for confirmation method recommendation, regression model for efficiency evaluation) and automatically generates the optimal confirmation flow. In Step 4, the variation providing unit scores multiple source code variations received from the generation unit using multidimensional evaluation metrics such as performance, security, readability, regional requirement compliance, and project characteristics, and automatically selects and presents the optimal variation by considering the user's emotion, history, geographic location, and social media activity. The variation providing unit dynamically optimizes display UI, provision order, and customization functions according to emotion estimation results and history. Through this series of steps, the present system, unlike conventional static and uniform business flows, achieves dynamic optimization and personalization in a multidimensional feature space using AI, and provides technical effects such as efficiency improvement, quality enhancement, and optimization of user experience in all processes of input, generation, confirmation, and variation selection. Application fields include software development support, medical information systems, process management in manufacturing, learning support in education, and automation of financial systems, and can be applied to any field that requires handling complex and diverse requirements.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL:https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned reception unit, generation unit, confirmation unit, and variation providing unit is implemented by at least one of, for example, the smart device 14 and the data processing apparatus 12. For example, the reception unit is implemented by a control unit 46A of the smart device 14 and inputs acceptance conditions and source code of a target system. The generation unit is implemented, for example, by a specific processing unit 290 of the data processing apparatus 12 and generates source code for modification using AI. The confirmation unit is implemented, for example, by the control unit 46A of the smart device 14 and confirms the generated source code. The variation providing unit is implemented, for example, by the specific processing unit 290 of the data processing apparatus 12 and provides a plurality of generated source code variations. The correspondence between each unit and the apparatus or control unit is not limited to the examples described above and various modifications are possible.

### Second Embodiment

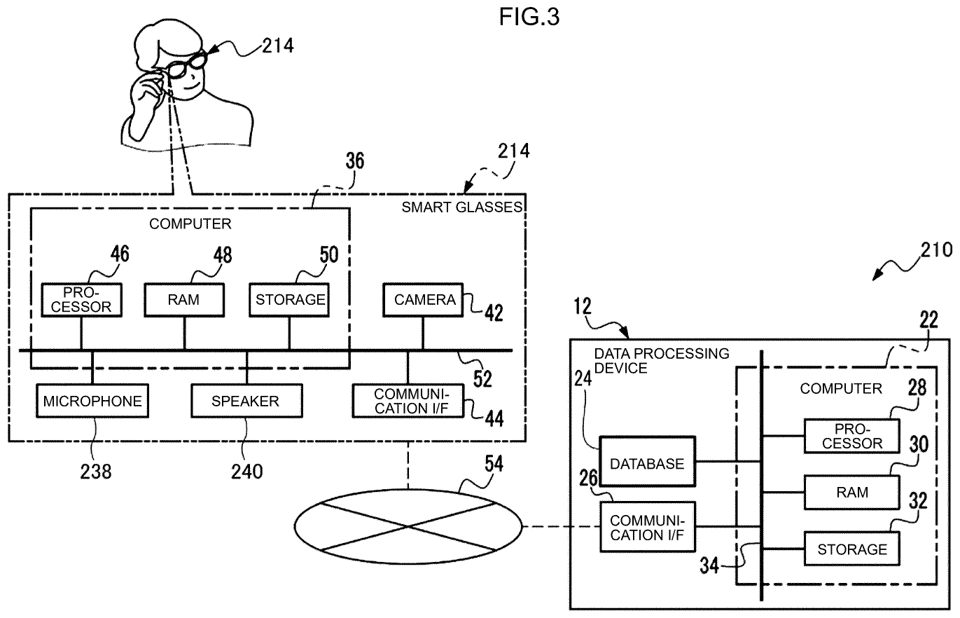

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

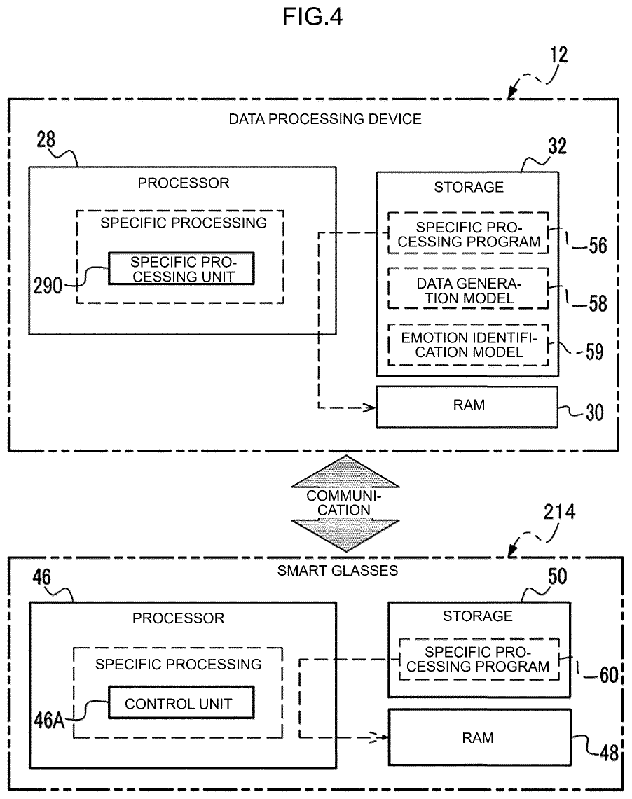

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned reception unit, generation unit, confirmation unit, and variation providing unit is implemented by at least one of, for example, the smart glasses 214 and the data processing apparatus 12. For example, the reception unit is implemented by a control unit 46A of the smart glasses 214 and inputs acceptance conditions and source code of a target system. The generation unit is implemented, for example, by a specific processing unit 290 of the data processing apparatus 12 and generates source code for modification using AI. The confirmation unit is implemented, for example, by the control unit 46A of the smart glasses 214 and confirms the generated source code. The variation providing unit is implemented, for example, by the specific processing unit 290 of the data processing apparatus 12 and provides a plurality of generated source code variations. The correspondence between each unit and the apparatus or control unit is not limited to the examples described above and various modifications are possible.

### Third Embodiment

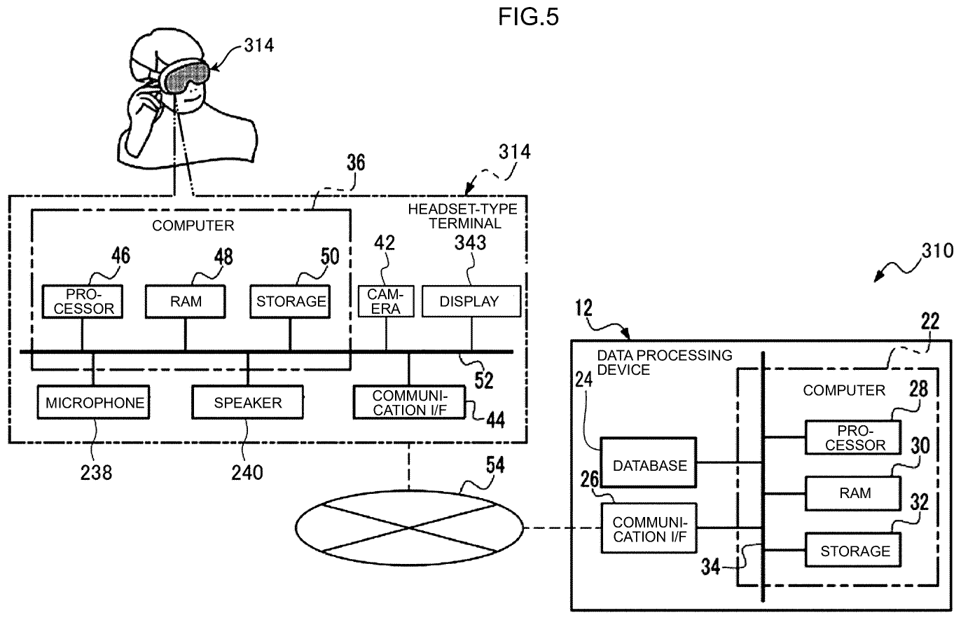

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

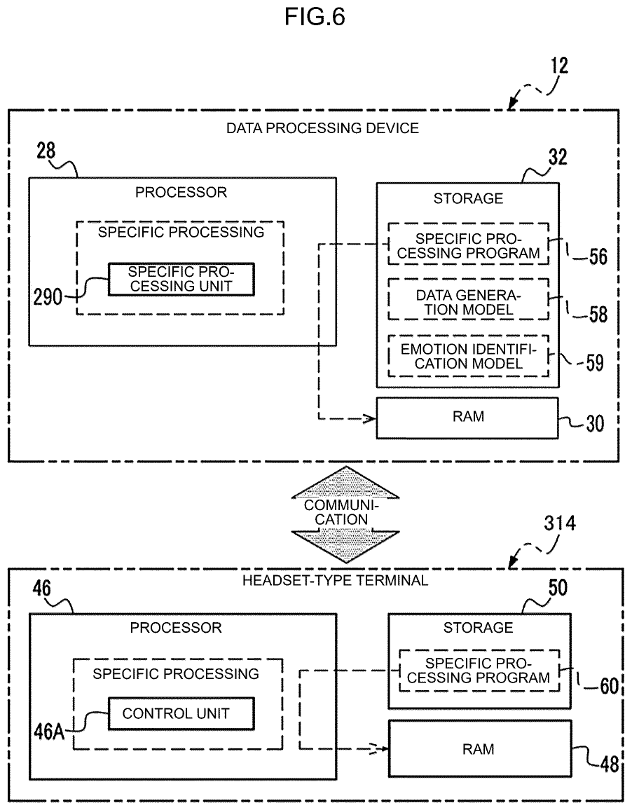

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned reception unit, generation unit, confirmation unit, and variation providing unit is implemented by at least one of, for example, the headset-type terminal 314 and the data processing apparatus 12. For example, the reception unit is implemented by a control unit 46A of the headset-type terminal 314 and inputs acceptance conditions and source code of a target system. The generation unit is implemented, for example, by a specific processing unit 290 of the data processing apparatus 12 and generates source code for modification using AI. The confirmation unit is implemented, for example, by the control unit 46A of the headset-type terminal 314 and confirms the generated source code. The variation providing unit is implemented, for example, by the specific processing unit 290 of the data processing apparatus 12 and provides a plurality of generated source code variations. The correspondence between each unit and the apparatus or control unit is not limited to the examples described above and various modifications are possible.

### Fourth Embodiment

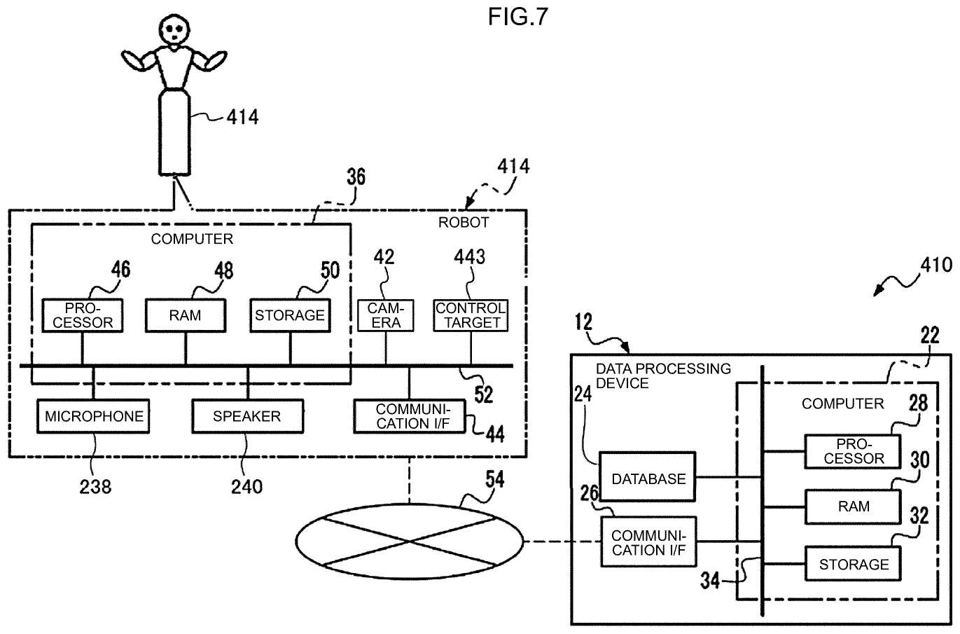

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

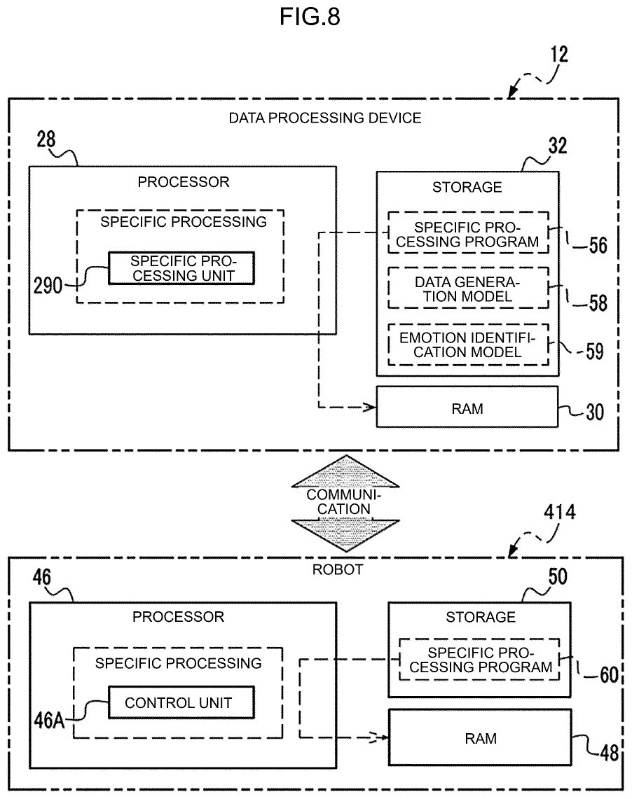

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned reception unit, generation unit, confirmation unit, and variation providing unit is implemented by at least one of, for example, the robot 414 and the data processing apparatus 12. For example, the reception unit is implemented by a control unit 46A of the robot 414 and inputs acceptance conditions and source code of a target system. The generation unit is implemented, for example, by a specific processing unit 290 of the data processing apparatus 12 and generates source code for modification using AI. The confirmation unit is implemented, for example, by the control unit 46A of the robot 414 and confirms the generated source code. The variation providing unit is implemented, for example, by the specific processing unit 290 of the data processing apparatus 12 and provides a plurality of generated source code variations. The correspondence between each unit and the apparatus or control unit is not limited to the examples described above and various modifications are possible.

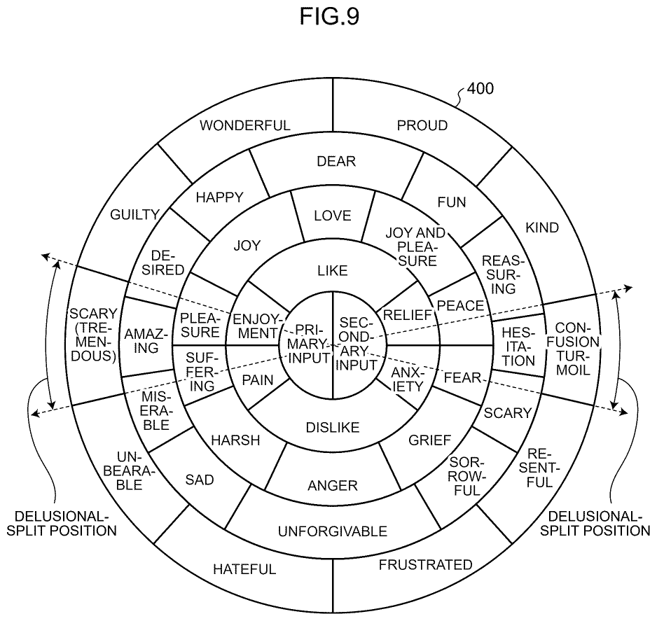

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

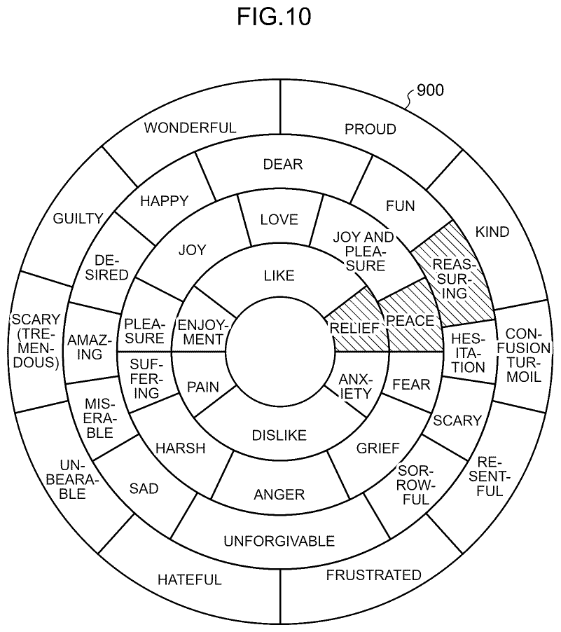

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1) A system comprising: a reception unit configured to input acceptance conditions; a reception unit configured to input source code of a target system; a generation unit configured to generate source code for modification based on information input by the reception unit; a confirmation unit configured to confirm the source code generated by the generation unit; and a variation providing unit configured to provide a plurality of source code variations generated by the generation unit.
(Supplementary Note 2) The system according to Supplementary Note 1, wherein the generation unit is configured to generate source code for modification using AI.
(Supplementary Note 3) The system according to Supplementary Note 1, wherein the confirmation unit is configured such that a developer confirms the generated source code and makes modifications as necessary.
(Supplementary Note 4) The system according to Supplementary Note 1, wherein the variation providing unit is configured to provide a plurality of generated source code variations.
(Supplementary Note 5) The system according to Supplementary Note 1, wherein the reception unit is configured to input acceptance conditions for tickets.
(Supplementary Note 6) The system according to Supplementary Note 1, wherein the reception unit is configured to input source code of the target system.
(Supplementary Note 7) The system according to Supplementary Note 1, wherein the reception unit is configured to estimate a user's emotion and adjust the method of inputting acceptance conditions based on the estimated emotion of the user.
(Supplementary Note 8) The system according to Supplementary Note 1, wherein the reception unit is configured to analyze a history of past acceptance conditions and propose an optimal input method.
(Supplementary Note 9) The system according to Supplementary Note 1, wherein the reception unit is configured to dynamically change input items according to the progress of the project when inputting acceptance conditions.
(Supplementary Note 10) The system according to Supplementary Note 1, wherein the reception unit is configured to estimate a user's emotion and determine the priority of acceptance conditions based on the estimated emotion of the user.
(Supplementary Note 11) The system according to Supplementary Note 1, wherein the reception unit is configured to preferentially input highly relevant conditions by considering the user's geographic location information when inputting acceptance conditions.
(Supplementary Note 12) The system according to Supplementary Note 1, wherein the reception unit is configured to analyze the user's social media activity and propose relevant conditions when inputting acceptance conditions.
(Supplementary Note 13) The system according to Supplementary Note 1, wherein the reception unit is configured to estimate a user's emotion and adjust the method of inputting source code based on the estimated emotion of the user.
(Supplementary Note 14) The system according to Supplementary Note 1, wherein the reception unit is configured to analyze a history of past source code input and propose an optimal input method.
(Supplementary Note 15) The system according to Supplementary Note 1, wherein the reception unit is configured to dynamically change input items according to the progress of the project when inputting source code.
(Supplementary Note 16) The system according to Supplementary Note 1, wherein the reception unit is configured to estimate a user's emotion and determine the priority of source code based on the estimated emotion of the user.
(Supplementary Note 17) The system according to Supplementary Note 1, wherein the reception unit is configured to preferentially input highly relevant code by considering the user's geographic location information when inputting source code.
(Supplementary Note 18) The system according to Supplementary Note 1, wherein the reception unit is configured to analyze the user's social media activity and propose relevant code when inputting source code.
(Supplementary Note 19) The system according to Supplementary Note 1, wherein the generation unit is configured to estimate a user's emotion and adjust the expression method of the generated source code based on the estimated emotion of the user.
(Supplementary Note 20) The system according to Supplementary Note 1, wherein the generation unit is configured to adjust the level of detail of generation based on the importance of the modification at the time of generation.
(Supplementary Note 21) The system according to Supplementary Note 1, wherein the generation unit is configured to apply different generation algorithms according to the category of the modification at the time of generation.
(Supplementary Note 22) The system according to Supplementary Note 1, wherein the generation unit is configured to estimate a user's emotion and adjust the length of the generated source code based on the estimated emotion of the user.
(Supplementary Note 23) The system according to Supplementary Note 1, wherein the generation unit is configured to determine the priority of generation based on the submission timing of the modification at the time of generation.
(Supplementary Note 24) The system according to Supplementary Note 1, wherein the generation unit is configured to adjust the order of generation based on the relevance of the modification at the time of generation.
(Supplementary Note 25) The system according to Supplementary Note 1, wherein the confirmation unit is configured to estimate a user's emotion and adjust the method of confirmation based on the estimated emotion of the user.
(Supplementary Note 26) The system according to Supplementary Note 1, wherein the confirmation unit is configured to refer to a history of past confirmations and propose an optimal confirmation method at the time of confirmation.
(Supplementary Note 27) The system according to Supplementary Note 1, wherein the confirmation unit is configured to dynamically change confirmation items according to the progress of the project at the time of confirmation.
(Supplementary Note 28) The system according to Supplementary Note 1, wherein the confirmation unit is configured to estimate a user's emotion and determine the priority of confirmation based on the estimated emotion of the user.
(Supplementary Note 29) The system according to Supplementary Note 1, wherein the confirmation unit is configured to preferentially confirm highly relevant confirmation items by considering the user's geographic location information at the time of confirmation.
(Supplementary Note 30) The system according to Supplementary Note 1, wherein the confirmation unit is configured to analyze the user's social media activity and propose relevant confirmation items at the time of confirmation.
(Supplementary Note 31) The system according to Supplementary Note 1, wherein the variation providing unit is configured to estimate a user's emotion and determine the priority of provided variations based on the estimated emotion of the user.
(Supplementary Note 32) The system according to Supplementary Note 1, wherein the variation providing unit is configured to refer to a history of past variation provision and propose an optimal provision method at the time of providing variations.
(Supplementary Note 33) The system according to Supplementary Note 1, wherein the variation providing unit is configured to dynamically change provision items according to the progress of the project at the time of providing variations.
(Supplementary Note 34) The system according to Supplementary Note 1, wherein the variation providing unit is configured to estimate a user's emotion and adjust the display method of provided variations based on the estimated emotion of the user.
(Supplementary Note 35) The system according to Supplementary Note 1, wherein the variation providing unit is configured to preferentially provide highly relevant variations by considering the user's geographic location information at the time of providing variations.
(Supplementary Note 36) The system according to Supplementary Note 1, wherein the variation providing unit is configured to analyze the user's social media activity and propose relevant variations at the time of providing variations.

What is claimed is:

1. A system comprising:
circuitry configured to:
receive, via a communication interface coupled to a packet-switched network, specification data comprising requirement parameters and program data associated with a target module;
generate, using a data generation model, modified program data based on the specification data and the program data, the data generation model comprising an encoder-decoder neural network that receives the specification data and an abstract syntax tree representation of the program data as multidimensional tensors and outputs the modified program data with an associated confidence score;
perform a validation operation on the modified program data by applying at least one of static analysis or automated test execution to the modified program data; and
generate a plurality of candidate program data sets by applying different inference parameters to the data generation model, each candidate program data set representing a distinct modification of the program data.

2. The system according to claim 1, wherein the specification data comprises at least one of functional requirements, non-functional requirements, or constraint conditions for a ticket in an agile development workflow.

3. The system according to claim 1, wherein the circuitry is further configured to perform preprocessing on the specification data comprising tokenization and syntactic analysis, and to perform preprocessing on the program data comprising conversion to the abstract syntax tree representation and generation of a dependency graph.

4. The system according to claim 1, wherein the encoder-decoder neural network comprises a Transformer-based architecture, and wherein the circuitry is further configured to apply temperature parameters and top-K sampling during inference to generate the plurality of candidate program data sets.

5. The system according to claim 1, wherein the circuitry is further configured to attach, to each of the plurality of candidate program data sets, highlight information identifying changed portions of the program data and explanatory text indicating a basis for the modification.

6. The system according to claim 1, wherein the different inference parameters comprise at least one of different temperature parameters, different pre-trained models, or different prompt configurations.

7. The system according to claim 1, wherein the validation operation comprises inputting the modified program data into a static analysis tool that performs at least one of bug detection based on the abstract syntax tree representation or security vulnerability scanning, and outputting a structured error report.

8. The system according to claim 1, wherein the circuitry is further configured to estimate an emotion of a user based on multimodal input data and to adjust a method of receiving the specification data based on the estimated emotion.

9. The system according to claim 8, wherein the multimodal input data comprises at least two of facial image data, voice waveform data, input text data, mouse operation log data, or keystroke interval data, and wherein the circuitry estimates the emotion by inputting the multimodal input data into an emotion estimation model comprising a fusion of an image convolutional neural network, a voice recurrent neural network, and a text Transformer.

10. The system according to claim 8, wherein the circuitry is further configured to, when the estimated emotion indicates stress, provide a simplified interface for receiving the specification data and minimize an input procedure, and when the estimated emotion indicates relaxation, provide detailed input options for receiving the specification data.

11. The system according to claim 1, wherein the circuitry is further configured to analyze a history of previously received specification data and to propose an input method for the specification data based on the history, the input method comprising at least one of automatic display of candidate specification data or selection of a preferred input modality.

12. The system according to claim 1, wherein the circuitry is further configured to adjust a level of detail of the modified program data based on an importance score assigned to the specification data, such that when the importance score exceeds a first threshold, the circuitry generates modified program data including exception handling, input validation, and detailed comments, and when the importance score is below a second threshold, the circuitry generates concise modified program data.

13. The system according to claim 1, wherein the circuitry is further configured to apply different generation algorithms according to a category of the specification data, the different generation algorithms comprising at least one of a pattern-matching model for error correction, a large language model for new function generation, or a reinforcement learning model for performance optimization.

14. The system according to claim 1, wherein the circuitry is further configured to estimate an emotion of a user and to adjust a length of the modified program data based on the estimated emotion, such that when the estimated emotion indicates urgency, the circuitry generates shortened modified program data, and when the estimated emotion indicates relaxation, the circuitry generates lengthened modified program data with detailed explanatory comments.

15. The system according to claim 1, wherein the circuitry is further configured to determine a priority of generating the modified program data based on a submission timing associated with the specification data, such that when a deadline is within a threshold period, the circuitry prioritizes generation of the modified program data.

16. The system according to claim 1, wherein the circuitry is further configured to dynamically change confirmation items for the validation operation according to a progress status of a project, such that at an initial stage of the project, the circuitry performs validation of basic items, and at a final stage of the project, the circuitry performs validation of pre-release confirmation items.

17. The system according to claim 1, wherein the circuitry is further configured to record a history of past validation operations and past modifications in a database, and to propose an optimal validation method based on the recorded history by applying at least one of time series analysis or frequency analysis to the recorded history.

18. A system comprising:
a communication interface coupled to a packet-switched network;
a processor;
a random-access memory; and
a memory storing a data generation model and an emotion identification model, wherein the data generation model comprises an encoder-decoder neural network obtained by performing deep learning on a neural network, and the emotion identification model comprises a multimodal fusion model;
circuitry configured to:
receive, via the communication interface, specification data comprising requirement parameters and program data associated with a target module from a client terminal;
perform preprocessing on the specification data comprising tokenization and syntactic analysis, and perform preprocessing on the program data comprising conversion to an abstract syntax tree representation and generation of a dependency graph;
generate, using the data generation model stored in the memory, modified program data by inputting the specification data and the abstract syntax tree representation of the program data as multidimensional tensors into the encoder-decoder neural network, the encoder-decoder neural network outputting modified program data fragments as token sequences with an associated confidence score;
perform a validation operation on the modified program data by inputting the modified program data into a static analysis tool and an automated test framework to evaluate quality, the validation operation outputting at least one of an error report or a test pass rate;
generate a plurality of candidate program data sets by applying different inference parameters to the data generation model, the different inference parameters comprising at least one of different temperature parameters or different pre-trained models; and
transmit, via the communication interface, the plurality of candidate program data sets to the client terminal.

19. The system according to claim 18, wherein the circuitry is further configured to estimate an emotion of a user by inputting multimodal input data comprising at least facial image data and voice waveform data into the emotion identification model stored in the memory, and to adjust at least one of a method of receiving the specification data, a level of detail of the modified program data, or a display method of the plurality of candidate program data sets based on the estimated emotion.

20. A method performed by circuitry of a system, the method comprising:
receiving, via a communication interface coupled to a packet-switched network, specification data comprising requirement parameters and program data associated with a target module;
generating, using a data generation model comprising an encoder-decoder neural network, modified program data based on the specification data and the program data, the encoder-decoder neural network receiving the specification data and an abstract syntax tree representation of the program data as multidimensional tensors and outputting the modified program data with an associated confidence score;
performing a validation operation on the modified program data by applying at least one of static analysis or automated test execution to the modified program data; and
generating a plurality of candidate program data sets by applying different inference parameters to the data generation model, each candidate program data set representing a distinct modification of the program data.
